(19) United States
(12) Patent Application Publication
(10) Pub. No.: US 2025/0016337 A1
(43) Pub. Date: Jan. 9, 2025

(54) BACKWARD COMPATIBLE CARRIAGE OF CODED UNITS FROM DIFFERENT CODECS

(71) Applicant: Nokia Technologies Oy, Espoo (FI)

(72) Inventors: Kashyap KAMMACHI SREEDHAR, Tampere (FI); Miska Matias HANNUKSELA, Tampere (FI); Lukasz KONDRAD, Munich (DE); Lauri Aleksi ILOLA, Tampere (FI)

(21) Appl. No.: 18/347,834

(22) Filed: Jul. 6, 2023

(51) Int. Cl. H04N 19/30; H04N 19/46

(52) U.S. Cl. CPC H04N 19/30; H04N 19/46

(57) ABSTRACT

An apparatus configured to: obtain a first bitstream, wherein the first bitstream is encoded according to a first coding method; obtain at least one second bitstream, wherein the at least one second bitstream is encoded according to a second coding method; and generate an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track.

### TECHNICAL FIELD

The example and non-limiting embodiments relate generally to media content encoding and decoding and, more particularly, to transmission and/or storage of encoded bitstreams.

### BACKGROUND

It is known, in media coding, to encode content as a base bitstream and an enhancement bitstream.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: obtain a first bitstream, wherein the first bitstream is encoded according to a first coding method; obtain at least one second bitstream, wherein the at least one second bitstream is encoded according to a second coding method; and generate an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track.

In accordance with one aspect, a method comprising: obtaining, with a user equipment, a first bitstream, wherein the first bitstream is encoded according to a first coding method; obtaining at least one second bitstream, wherein the at least one second bitstream is encoded according to a second coding method; and generating an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track.

In accordance with one aspect, an apparatus comprising means for: obtaining a first bitstream, wherein the first bitstream is encoded according to a first coding method; obtaining at least one second bitstream, wherein the at least one second bitstream is encoded according to a second coding method; and generating an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track.

In accordance with one aspect, a non-transitory computer-readable medium comprising program instructions stored thereon for performing at least the following: obtaining a first bitstream, wherein the first bitstream is encoded according to a first coding method; obtaining at least one second bitstream, wherein the at least one second bitstream is encoded according to a second coding method; and generating an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track.

In accordance with one aspect, an apparatus comprising: at least one processor; and at least one memory storing instructions that, when executed by the at least one processor, cause the apparatus at least to: obtain an encapsulated file, wherein a track of the encapsulated file comprises a first bitstream and sample auxiliary information of the track comprises at least one second bitstream, wherein the encapsulated file comprises, at least: an indication that the first bitstream is encapsulated in samples of the track, and an indication that the at least one second bitstream is encapsulated in the sample auxiliary information of the track; obtain, from the encapsulated file, the first bitstream, wherein the first bitstream is encoded according to a first coding method; and obtain, from the encapsulated file, the at least one second bitstream, wherein the second bitstream is encoded according to a second coding method.

In accordance with one aspect, a method comprising: obtaining, with a user equipment, an encapsulated file, wherein a track of the encapsulated file comprises a first bitstream and sample auxiliary information of the track comprises at least one second bitstream, wherein the encapsulated file comprises, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream is encoded according to a first coding method; and obtaining, from the encapsulated file, the at least one second bitstream, wherein the second bitstream is encoded according to a second coding method.

In accordance with one aspect, an apparatus comprising means for: obtaining an encapsulated file, wherein a track of the encapsulated file comprises a first bitstream and sample auxiliary information of the track comprises at least one second bitstream, wherein the encapsulated file comprises, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream is encoded according to a first coding method; and obtaining, from the encapsulated file, the at least one second bitstream, wherein the second bitstream is encoded according to a second coding method.

In accordance with one aspect, a non-transitory computer-readable medium comprising program instructions stored thereon for performing at least the following: obtaining an encapsulated file, wherein a track of the encapsulated file comprises a first bitstream and sample auxiliary information of the track comprises at least one second bitstream, wherein the encapsulated file comprises, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream is encoded according to a first coding method; and obtaining, from the encapsulated file, the at least one second bitstream, wherein the second bitstream is encoded according to a second coding method.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3A is a diagram illustrating features as described herein;

FIG. 3B is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein;

FIG. 11 is a diagram illustrating features as described herein;

FIG. 12 is a flowchart illustrating steps as described herein; and

FIG. 13 is a flowchart illustrating steps as described herein.

### DETAILED DESCRIPTION OF EMBODIMENTS

The following abbreviations that may be found in the specification and/or the drawing figures are defined as follows:
3D-HEVC three-dimensional high efficiency video coding
3GPP third generation partnership project
4CC four character code
4G fourth generation
5G fifth generation
5GC 5G core network
AI additional information
ALF adaptive loop filtering
AMVP advanced motion vector prediction
AOM alliance of open media
APS adaptation parameter set
AR augmented reality
AU access unit
AVC advanced video coding
BLA broken link access
CCLM cross component linear model intra prediction
CDMA code division multiple access
CE consumer electronics
CGS coarse-granularity scalability
CPU central processing unit
CRA clean random access
CRAN cloud radio access network
CTB coding tree block
CTU coding tree unit
CU coding unit
CVS coded video sequence
DASH dynamic adaptive streaming over HTTP
DCT discrete cosine transform
DPB decoded picture buffer
eNB (or eNodeB) evolved Node B (e.g., an LTE base station)
EN-DC E-UTRA-NR dual connectivity
en-gNB or En-gNBnode providing NR user plane and control plane protocol terminations towards the UE, and acting as secondary node in EN-DC
EOB end of bitstream
EOS end of sequence
E-UTRA evolved universal terrestrial radio access, i.e., the LTE radio access technology
EVC essential video coding
FDMA frequency division multiple access
FGS fine-granularity scalability
GC global configuration
gNB (or gNodeB) base station for 5G/NR, i.e., a node providing NR user plane and control plane protocol terminations towards the UE, and connected via the NG interface to the 5GC
GOP group of pictures
GPU graphical processing unit
GSM global systems for mobile communications
HEVC high efficiency video coding
HMD head-mounted display
HPS header parameter set
HRD hypothetical reference decoder
IBC intra block copy
IDR instantaneous decoding refresh
IEC international electrotechnical commission
IEEE Institute of Electrical and Electronics Engineers
IMD integrated messaging device
IMS instant messaging service
IoT Internet of Things
IRAP intra random access point
ISO international standards organization
ISOBMFF international standards organization base media file format
TU-T international telecommunication union
JCT-VC joint collaborative team-video coding
JVET joint video experts team
JVT joint video team
LCEVC low complexity enhancement video coding
LCU largest coding unit
LTE long term evolution
MCTS motion-constrained tile set
MGS medium-granularity scalability
MMS multimedia messaging service
MMVD merge with motion vector difference
MPEG Moving Picture Experts Group
MPEG-I Moving Picture Experts Group immersive codec family
MR mixed reality
MVC multiview video coding
MVD motion vector difference
MV-HEVC multiview high efficiency video coding
NAL network abstraction layer
NALU network abstraction layer unit
ng or NG new generation
ng-eNB or NG-eNB new generation eNB
NR new radio
N/W or NW network
OBU open bitstream unit
O-RAN open radio access network
OTT over-the-top
PC personal computer
PDA personal digital assistant
PDPC position dependent intra prediction combination
PH picture header
PID packet identifier
POC picture order count
PPS picture parameter set
PU prediction unit
RADL random access decodable leading
RAP random access point
RASL random access skipped leading
RBSP raw byte sequence payload
RDO rate-distortion optimization
REXT fidelity range extensions
RPLR reference picture list reordering
SAI sample auxiliary information
SAO sample adaptive offset
SC sequence configuration
SEI supplemental enhancement information
SHVC scalable high efficiency video coding
SMS short messaging service
SNR signal-to-noise
SOP structure of pictures
SPS sequence parameter set
STSA step-wise temporal sub-layer access
SVC scalable video coding
TCP-IP transmission control protocol-internet protocol
TDMA time division multiple access
TMVP temporal motion vector prediction
TRAIL trailing picture
TSA temporal sub-layer access
UE user equipment (e.g., a wireless, typically mobile device)
ULLRC ultra-reliable low-latency communication
UMTS universal mobile telecommunications system
URI uniform resource identifier
URL uniform resource locator
URN uniform resource name
USB universal serial bus
VR virtual reality
WLAN wireless local area network
V3C visual volumetric video-based coding
VCEG video coding experts group
VCL video coding layer
V-DMC video-based dynamic mesh coding
VNR virtualized network function
VPS video parameter set
VUI video usability information
VVC versatile video coding
XML extensible markup language

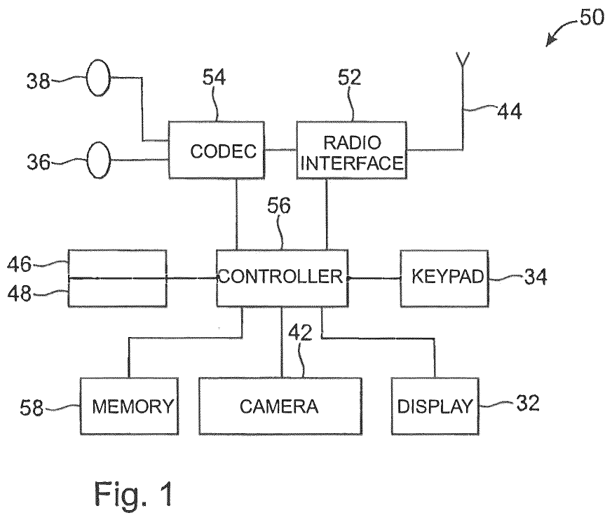

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-1) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments of the present disclosure may be any one of: an earpiece, speaker, or an analogue audio or digital audio output connection. The electronic device 50 may also comprise a battery (or in other example embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments of the present disclosure the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication for signals example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

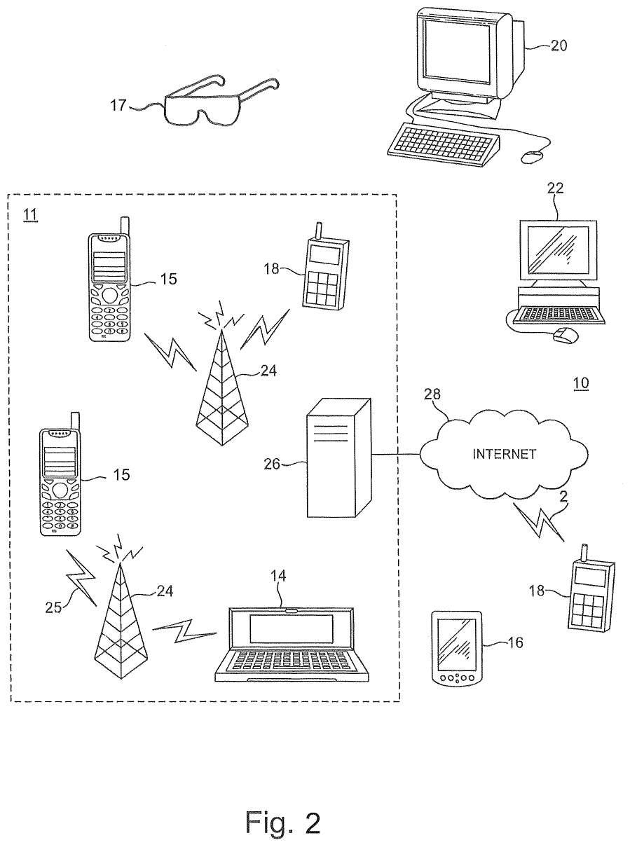

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments of the present disclosure.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments of the present disclosure may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments of the present disclosure may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IoT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Features as described herein may generally relate to the LOW Complexity Enhancement Video Coding (LCEVC) standard, specified in ISO/IEC 23094-2. LCEVC is reportedly a low complexity solution to apply enhancement to existing video coding bitstreams generated using other video coding systems (e.g. AVC, HEVC, EVC, VVC, etc.).

Since the LCEVC elementary streams carry enhancement to a “base” codec such as the ones listed above, the LCEVC elementary stream refers to a “base” codec elementary stream, so that the LCEVC stream can be decoded in conjunction with the “base” codec elementary stream, while the “base” codec elementary stream can be decoded independently of the LCEVC elementary stream.

For convenience the text in the current document uses the terms LCEVC elementary stream, LCEVC stream and LCEVC bitstream as alternates of each other and are used interchangeably.

The current definition of carriage and storage of LCEVC bitstream and base the bitstream is specified in MDS21211_WG03_N00490, which takes a dual-track approach with two separate streams (e.g. packet identifiers (PIDs) or tracks), which can be linked together with a dependency mechanism (e.g. track reference tref).

However, many applications which are deployed currently support single track processing. Hence, there is a requirement to combine LCEVC bitstream with the base bitstream to form a single-track representation. Example embodiments of the present disclosure may present solutions which may be used to characterize combinations of bitstreams encoded with different coding standard into a single representation.

Features as described herein may generally relate to video-based dynamic mesh coding (V-DMC). V-DMC (ISO/IEC 23090-29) is another application form of visual volumetric video-based coding (V3C) that aims for integration of mesh compression into the V3C family of standards. The standard is under development and at working draft (WD) stage (MDS22775_WG07_N00611).

The retained technology after the Call-for-proposal (CfP) result analysis is based on multiresolution mesh analysis and coding. This approach consists of the following:
(1) Generating a base mesh that is a simplified (i.e. low resolution) mesh approximation of the original mesh, called a base mesh (this is done for all frames of the dynamic mesh sequence).
(2) Performing several mesh subdivision in iterative steps (e.g. each triangle is converted into four triangles by connecting the triangle edge midpoints on the generated base mesh, generating other approximation meshes.
(3) Defining displacement vectors, also named error vectors, for each vertex of each mesh approximation.
(4) For each subdivision level, by adding the displacement vectors to the subdivided mesh vertices, generating the best approximation of the original mesh at that resolution, given the base mesh and prior subdivision levels.
(5) The displacement vectors may undergo a lazy wavelet transform prior to compression.
(6) The attribute map of the original mesh is transferred to the deformed mesh at the highest resolution (i.e. subdivision level) such that texture coordinates are obtained for the deformed mesh and a new attribute map is generated.

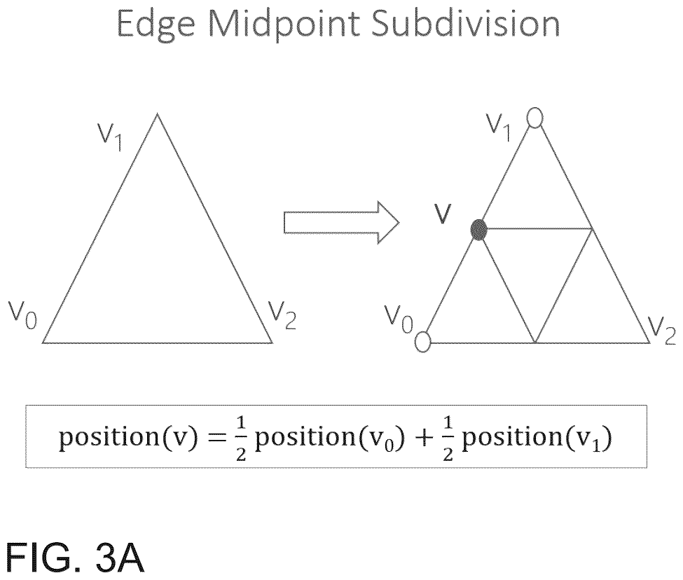

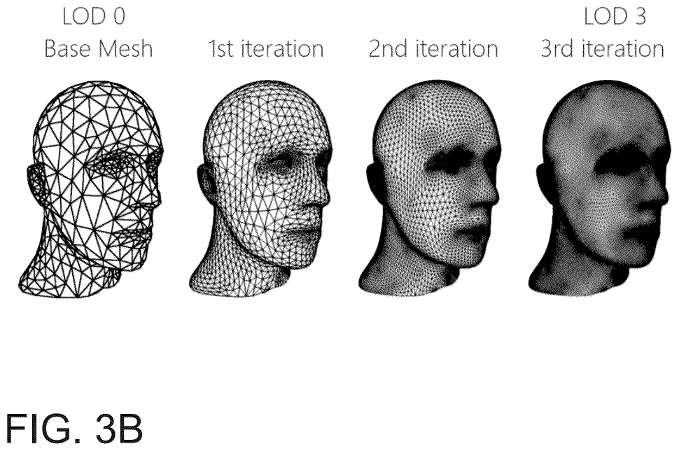

FIG. 3A depicts an example of mesh subdivision in iterative steps. In the example of FIG. 3A, which illustrates edge midpoint subdivision, each triangle is converted into four triangles by connecting the triangle edge midpoints on a generated base mesh, thereby generating other approximation meshes.

FIG. 3B shows an example of the base mesh together with the other approximation meshes constructed with three iterative steps. It may be noted that a greater number of triangles are included after each iteration.

The V-DMC generates that compressed bitstream(s), which later on are packed in V3C units and create V3C bitstream by concatenating V3C units. For example, a sub-bitstream with the encoded base mesh using a mesh codec. For example, a sub-bitstream with the displacement vectors: packed in an image and encoded using a video codec, or arithmetic encoded as defined in Annex J of WD ISO/IEC 23090, MDS22775_WG07_N00611. For example, a sub-bitstream with the attribute map encoded using a video codec. For example, a sub-bitstream (atlas) that contains all metadata required to decode and reconstruct the mesh sequence based on the aforementioned sub-bitstreams. The signaling of the metadata is based on the V3C syntax and includes necessary extensions that are specific to meshes.

Features as described herein may generally relate to the ISO base media file format (ISOBMFF). Available media file format standards include the International Standards Organization (ISO) base media file format (ISO/IEC 14496-12, which may be abbreviated ISOBMFF), the Moving Picture Experts Group (MPEG)-4 file format (ISO/IEC 14496-14, also known as the MP4 format), and the file format for the network abstraction layer (NAL) unit structured video (ISO/IEC 14496-15).

Some concepts, structures, and specifications of ISOBMFF are described below as an example of a container file format, based on which some example embodiments of the present disclosure may be implemented. The aspects of the disclosure are not limited to ISOBMFF; rather, the description is given for one possible basis on top of which at least some example embodiments may be partly or fully realized.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’), and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames. For video tracks, a media sample may correspond to a coded picture or an access unit.

A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleDescriptionBox, which gives detailed information about the coding type used, and any initialization information needed for that coding. The SampleDescriptionBox contains an entry-count and as many sample entries as the entry-count indicates. The format of sample entries is track-type specific, but derived from generic classes (e.g. VisualSampleEntry, AudioSampleEntry). Which type of sample entry form is used for derivation of the track-type specific sample entry format is determined by the media handler of the track.

A sample entry may comprise a configuration box, which itself may comprise a configuration record. The configuration record may comprise information that may be used to configure a decoder instance for decoding the samples mapped to the sample entry.

A sample table contains all the time and data indexing of the media samples in a track. Using the tables here, it is possible to locate samples in time, determine their type (e.g. I-frame or not), and determine their size, container, and offset into that container.

If the track that contains the SampleTableBox refers to no data, then the SampleTableBox does not need to contain any sub-boxes; this may not be a very useful media track.

If the track that the SampleTableBox is contained in refers to data, then the following sub-boxes are required: SampleDescriptionBox, SampleSizeBox (or CompactSampleSizeBox), SampleToChunkBox, and ChunkOffsetBox (or ChunkLargeOffsetBox). Further, the SampleDescriptionBox shall contain at least one entry. A SampleDescriptionBox is required because it contains the data reference index field, which indicates which DataEntry to use to retrieve the media samples. Without the SampleDescriptionBox, it is not possible to determine where the media samples are stored.

The syntax of SampleTableBox in ISOBMFF is as follows:
aligned(8) class SampleTableBox extends Box (‘stbl’) {
}

A SampleSizeBox contains the sample count and a table giving the size in bytes of each sample. This allows the media data itself to be unframed. The total number of samples in the media is always indicated in the sample count.

There are two variants of the sample size box. The first variant has a fixed size 32-bit field for representing the sample sizes; it permits defining a constant size for all samples in a track. The second variant permits smaller size fields, to save space when the sizes are varying but small. One of these boxes shall be present; the first version may be preferred for maximum compatibility.

A sample size of zero is not prohibited in general, but it must be valid and defined for the coding system, as defined by the sample entry, that the sample belongs to.

The syntax of SampleSizeBox in ISOBMFF is as follows:

| aligned(8) class SampleSizeBox extends FullBox(‘stsz’, | |
|---|---|
| version = 0, 0) { | |
| unsigned int(32) | sample_size; |
| unsigned int(32) | sample_count; |
| if (sample_size==0) { | |
| for (i=1; i <= sample_count; i++) { | |
| unsigned int(32) | entry_size; |

```
    }
  }
}
```

The semantics of SampleSizeBox structure in ISOBMFF is as follows. The version is an integer that specifies the version of this box. The sample_size is integer specifying the default sample size. If all the samples are the same size, this field contains that size value. If this field is set to 0, then the samples have different sizes, and those sizes are stored in the sample size table. If this field is not 0, it specifies the constant sample size, and no array follows. The sample_count is an integer that gives the number of samples in the track; if sample-size is 0, then it is also the number of entries in the following table. The entry_size is an integer specifying the size of a sample, indexed by its number.

The syntax of CompactSampleSizeBox in ISOBMFF is as follows:

| aligned(8) class CompactSampleSizeBox | |
|---|---|
| extends FullBox(‘stz2’, version = 0, 0) { | |
| unsigned int(24) | reserved = 0; |
| unsigned int(8) | field_size; |
| unsigned int(32) | sample_count; |

```
  for (i=1; i <= sample_count; i++) {
    unsigned int(field_size) entry_size;
  }
}
```

The semantics of CompactSampleSizeBox structure in ISOBMFF is as follows. The version is an integer that specifies the version of this box. The field_size is an integer specifying the size in bits of the entry_size syntax elements; it shall take the value 4, 8 or 16. If the value 4 is used, then each byte contains two values: entry[i]<<4+entry[i+1]; if the sizes do not fill an integral number of bytes, the last byte is padded with zeros. The sample_count is an integer that gives the number of entry_size syntax elements. The entry_size is an integer specifying the size of a sample, indexed by its number.

The track reference mechanism can be used to associate tracks with each other. The TrackReferenceBox (‘tref’) includes box(es), each of which provides a reference from the containing track to a set of other tracks. These references are labeled through the box type (e.g. the four-character code of the box) of the contained box(es).

The ISO Base Media File Format contains three mechanisms for timed metadata that can be associated with particular samples: sample groups, timed metadata tracks, and sample auxiliary information. A derived specification may provide similar functionality with one or more of these three mechanisms.

A sample grouping in the ISO base media file format and its derivatives, such as ISO/IEC 14496-15, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. The SampleToGroupBox may comprise a grouping_type_parameter field that can be used, for example, to indicate a sub-type of the grouping.

In ISOMBFF, an edit list provides a mapping between the presentation timeline and the media timeline. Among other things, an edit list provides for the linear offset of the presentation of samples in a track, provides for the indication of empty times and provides for a particular sample to be dwelled on for a certain period of time. The presentation timeline may be accordingly modified to provide for looping, such as for the looping videos of the various regions of the scene. One example of the box that includes the edit list, the EditListBox, is provided below:

```
unsigned int(32) entry_count;
for (i=1; i <= entry_count; i++) {
  if (version==1) {
  unsigned int(64) segment_duration;
  int(64) media_time;
} else { // version==0
  unsigned int(32) segment_duration;
  int(32) media_time;
}
int(16) media_rate_integer;
int(16) media_rate_fraction = 0;
}
}
```

In ISOBMFF, an EditListBox may be contained in EditBox, which is contained in TrackBox (‘trak’).

In this example of the edit list box, flags specifies the repetition of the edit list. By way of example, setting a specific bit within the box flags (the least significant bit, i.e. flags & 1 in ANSI-C notation, where & indicates a bit-wise AND operation) equal to 0 specifies that the edit list is not repeated, while setting the specific bit (i.e. flags & 1 in ANSI-C notation) equal to 1 specifies that the edit list is repeated. The values of box flags greater than 1 may be defined to be reserved for future extensions. As such, when the edit list box indicates the playback of zero or one samples, (flags & 1) shall be equal to zero. When the edit list is repeated, the media at time 0 resulting from the edit list follows immediately the media having the largest time resulting from the edit list such that the edit list is repeated seamlessly.

In ISOBMFF, a Track group enables grouping of tracks based on certain characteristics or the tracks within a group have a particular relationship. Track grouping, however, does not allow any image items in the group.

The syntax of TrackGroupBox in ISOBMFF is as follows:

```
aligned(8) class TrackGroupBox extends Box (‘trgr’) {
}
aligned(8) class TrackGroupTypeBox(unsigned int(32)
track_group_type) extends FullBox(track_group_type, version
= 0, flags = 0)
{
  unsigned int(32) track_group_id;
  // the remaining data may be specified for a particular
track_group_type
}
```

The track_group_type indicates the grouping_type and shall be set to one of the following values, or a value registered, or a value from a derived specification or registration: ‘msrc’ indicates that this track belongs to a multi-source presentation. The tracks that have the same value of track_group_id within a TrackGroupTypeBox of track_group_type ‘msrc’ are mapped as being originated from the same source. For example, a recording of a video telephony call may have both audio and video for both participants, and the value of track_group_id associated with the audio track and the video track of one participant differs from the value of track_group_id associated with the tracks of the other participant.

The pair of track_group_id and track_group_type identifies a track group within the file. The tracks that contain a particular TrackGroupTypeBox having the same value of track_group_id and track_group_type belong to the same track group.

The Entity grouping is similar to track grouping but enables grouping of both tracks and image items in the same group.

The syntax of EntityToGroupBox in ISOBMFF is as follows:

```
aligned(8) class EntityToGroupBox(grouping_type, version,
flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
}
```

The group_id is a non-negative integer assigned to the particular grouping that shall not be equal to any group_id value of any other EntityToGroupBox, any item_ID value of the hierarchy level (file, movie, or track) that contains the GroupsListBox, or any track_ID value (when the GroupsListBox is contained in the file level).

The num_entities_in_group specifies the number of entity_id values mapped to this entity group.

The entity_id is resolved to an item, when an item with item_ID equal to entity_id is present in the hierarchy level (file, movie, or track) that contains the GroupsListBox, or to a track, when a track with track_ID equal to entity_id is present and the GroupsListBox is contained in the file level.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data, or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is always stored in the same file as the samples to which it relates, as they share the same data reference (‘dref’) structure. However, this data may be located anywhere within this file, using auxiliary information offsets (‘saio’) to indicate the location of the data.

Whether sample auxiliary information is permitted or required may be specified by the brands or the coding format in use. The format of the sample auxiliary information is determined by aux_info_type. If aux_info_type and aux_info_type_parameter are omitted, then the implied value of aux_info_type is either (a) in the case of transformed content, such as protected content, the scheme_type included in the ProtectionSchemeInfoBox or ScrambleSchemeInfoBox, or otherwise (b) the sample entry type. In the case of tracks containing multiple transformations, aux_info_type and aux_info_type_parameter shall not be omitted. The default value of the aux_info_type_parameter is 0. Some values of aux_info_type may be restricted to be used only with particular track types. A track may have multiple streams of sample auxiliary information of different types.

While aux_info_type determines the format of the auxiliary information, several streams of auxiliary information having the same format may be used when their value of aux_info_type_parameter differs. The semantics of aux_info_type_parameter for a particular aux_info_type value shall be specified along with specifying the semantics of the particular aux_info_type value and the implied auxiliary information format.

This box provides the size of the auxiliary information for each sample. For each instance of this box, there shall be a matching SampleAuxiliaryInformationOffsetsBox with the same values of aux_info_type and aux_info_type_parameter, providing the offset information for this auxiliary information.

The syntax of SampleAuxiliaryInformationSizesBox in ISOBMFF is given below:

```
aligned(8) class SampleAuxiliaryInformationSizesBox
  extends FullBox(‘saiz’, version = 0, flags)
{
  if (flags & 1) {
    unsigned int(32) aux_info_type;
    unsigned int(32) aux_info_type_parameter;
  }
  unsigned int(8) default_sample_info_size;
  unsigned int(32) sample_count;
  if (default_sample_info_size == 0) {
    unsigned int(8) sample_info_size[ sample_count ];
  }
}
```

The different fields are defined as follows.

The aux_info_type is an integer that identifies the type of the sample auxiliary information. At most one occurrence of this box with the same values for aux_info_type and aux_info_type_parameter shall exist in the containing box.

The aux_info_type_parameter identifies the “stream” of auxiliary information having the same value of aux_info_type and associated to the same track. The semantics of aux_info_type_parameter are determined by the value of aux_info_type.

The default_sample_info_size is an integer specifying the sample auxiliary information size for the case where all the indicated samples have the same sample auxiliary information size. If the size varies, then this field shall be zero.

The sample_count is an integer that gives the number of samples for which a size is defined. For a SampleAuxiliaryInformationSizesBox appearing in the SampleTableBox, this shall be the same as, or less than, the sample_count within the SampleSizeBox or CompactSampleSizeBox. For a SampleAuxiliaryInformationSizesBox appearing in a TrackFragmentBox, this shall be the same as, or less than, the sum of the sample_count entries within the TrackRunBoxes of the track fragment. If this is less than the number of samples, then auxiliary information is supplied for the initial samples, and the remaining samples have no associated auxiliary information.

The sample_info_size gives the size of the sample auxiliary information in bytes. This may be zero to indicate samples with no associated auxiliary information.

The SampleAuxiliaryInformationOffsetsBox provides the position information for the sample auxiliary information, in a way similar to the chunk offsets for sample data.

The syntax of SampleAuxiliaryInformationOffsetsBox in ISOBMFF is as follows:

```
aligned(8) class SampleAuxiliaryInformationOffsetsBox
  extends FullBox(‘saio’, version, flags)
{
  if (flags & 1) {
    unsigned int(32) aux_info_type;
    unsigned int(32) aux_info_type_parameter;
  }
  unsigned int(32) entry_count;
  if ( version == 0 ) {
    unsigned int(32) offset[ entry_count ];
  }
  else {
    unsigned int(64) offset[ entry_count ];
  }
}
```

The aux_info_type and aux_info_type_parameter are defined as in the SampleAuxiliaryInformationSizesBox.

The entry_count gives the number of entries in the following table. For a SampleAuxiliaryInformationOffsetsBox appearing in a Sample Table Box, this shall be equal to one or to the value of the entry_count field in the ChunkOffsetBox or ChunkLargeOffsetBox. For a SampleAuxiliaryInformationOffsetsBox appearing in a TrackFragmentBox, this shall be equal to one or to the number of TrackRunBoxes in the TrackFragmentBox.

The offset gives the position in the file of the Sample Auxiliary Information for each Chunk or Track Fragment Run. If entry_count is one, then the Sample Auxiliary Information for all Chunks or Runs is contiguous in the file in chunk or run order. When in the SampleTableBox, the offsets are relative to the same base offset as derived for the respective samples through the data_reference_index of the sample entry referenced by the samples. In a TrackFragmentBox, this value is relative to the base offset established by the TrackFragmentHeaderBox in the same track fragment.

When sample auxiliary information is present in the MovieFragmentBox, the offsets in the SampleAuxiliaryInformationOffsetsBox are treated the same as the data_offset in the TrackRunBox, that is, they are relative to any base data offset established for that track fragment.

If only one offset is provided, then the Sample Auxiliary Information for all the track runs in the fragment is stored contiguously, otherwise exactly one offset shall be provided for each track run.

If the field default_sample_info_size is non-zero in one of these boxes, then the size of the auxiliary information is constant for the identified samples.

In addition, if: this box is present in the MovieBox; the default_sample_info_size is non-zero in the box in the MovieBox; and the SampleAuxiliaryInformationSizesBox is absent in a movie fragment, then the auxiliary information has this same constant size for every sample in the movie fragment also. It is then not necessary to repeat the box in the movie fragment.

Files conforming to the ISOBMFF may contain any non-timed objects, referred to as items, meta items, or metadata items, in a meta box (four-character code: ‘meta’). While the name of the meta box refers to metadata, items can generally contain metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id), which is an integer value. The metadata items may be for example stored in the ‘idat’ box of the meta box or in an ‘mdat’ box or reside in a separate file. If the metadata is located external to the file, then its location may be declared by the DataInformationBox (four-character code: ‘dinf’). In the specific case that the metadata is formatted using extensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored/fragmented into extents, for example to enable interleaving. An extent is a contiguous subset of the bytes of the resource. The resource can be formed by concatenating the extents.

A video codec consists of an encoder and a decoder. The encoder transforms the input video into a compressed representation suited for storage/transmission. The decoder can uncompress the compressed video representation back into a viewable form. A video encoder and/or a video decoder may also be separate from each other (i.e. need not form a codec). The encoder may discard some information in the original video sequence in order to represent the video in a more compact form (that is, at a lower bitrate).

Hybrid video encoders, for example many encoder implementations of ITU-T H.263 and H.264, may encode the video information in two phases. Firstly, pixel values in a certain picture area (or “block”) are predicted, for example by motion compensation means (i.e. finding and indicating an area in one of the previously coded video frames that corresponds closely to the block being coded) or by spatial means (i.e. using the pixel values around the block to be coded in a specified manner). Secondly, the prediction error (i.e. the difference between the predicted block of pixels and the original block of pixels) is coded. This may be done by transforming the difference in pixel values using a specified transform (e.g. discrete cosine transform (DCT) or a variant of it), quantizing the coefficients and entropy coding the quantized coefficients. By varying the fidelity of the quantization process, the encoder can control the balance between the accuracy of the pixel representation (i.e. picture quality) and size of the resulting coded video representation (i.e. file size or transmission bitrate).

In temporal prediction, the sources of prediction are previously decoded pictures (a.k.a. reference pictures). In intra block copy (IBC; a.k.a. intra-block-copy prediction), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction, provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction, the sources of prediction are previously decoded pictures. Intra prediction utilizes the fact that adjacent pixels within the same picture are likely to be correlated. Intra prediction can be performed in spatial or transform domain; either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors, and only the difference relative to the motion vector predictor may be coded. Prediction of coding parameters and intra prediction may be collectively referred to as in-picture prediction.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H. 264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team-Video Coding (JCT-VC) of VCEG and MPEG. The standard is published both by parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

SHVC, MV-HEVC, and 3D-HEVC use a common basis specification, specified in Annex F of the version 2 of the HEVC standard. This common basis comprises, for example, high-level syntax and semantics, for example specifying some of the characteristics of the layers of the bitstream, such as inter-layer dependencies, as well as decoding processes, such as reference picture list construction, including inter-layer reference pictures and picture order count derivation for multi-layer bitstream. Annex F may also be used in potential subsequent multi-layer extensions of HEVC.

It is to be understood that even though a video encoder, a video decoder, encoding methods, decoding methods, bitstream structures, and/or example embodiments may be described in the following with reference to specific extensions, such as SHVC and/or MV-HEVC, they are generally applicable to any multi-layer extensions of HEVC, and even more generally to any multi-layer video coding scheme.

The Versatile Video Coding standard (which may be abbreviated VVC, H.266, or H. 266/VVC) was developed by the Joint Video Experts Team (JVET), which is a collaboration between the ISO/IEC MPEG and ITU-T VCEG. Extensions to VVC are presently under development.

A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC and HEVC are described in this section as an example of a video encoder, decoder, encoding method, decoding method, and a bitstream structure, wherein the example embodiments may be implemented. Some of the key definitions, bitstream and coding structures, and concepts of H.264/AVC are the same as in HEVC; accordingly, they are described below jointly. The aspects of the present disclosure are not limited to H. 264/AVC or HEVC, but rather the description is given for one possible basis on top of which the example embodiments may be partly or fully realized. Many aspects described below in the context of H. 264/AVC or HEVC may apply to VVC, and the aspects of the present disclosure may hence be applied to VVC.

Similarly to many earlier video coding standards, the bitstream syntax and semantics, as well as the decoding process for error-free bitstreams, are specified in H.264/AVC and HEVC. The encoding process is not specified, but encoders must generate conforming bitstreams. Bitstream and decoder conformance can be verified with the Hypothetical Reference Decoder (HRD). The in with standards contain coding tools that help coping transmission errors and losses, but the use of the tools in encoding is optional, and no decoding process has been specified for erroneous bitstreams.

The elementary unit for the input to an H. 264/AVC or HEVC encoder, and the output of an H.264/AVC or HEVC decoder, respectively, is a picture. A picture given as an input to an encoder may also be referred to as a source picture, and a picture decoded by a decoded may be referred to as a decoded picture.

The source and decoded pictures are each comprised of one or more sample arrays, such as one of the following sets of sample arrays: luma (Y) only (monochrome); luma and two chroma (YCbCr or YCgCo); green, blue, and red (GBR, also known as RGB); or arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr, regardless of the actual color representation method in use. The actual color representation method in use can be indicated, for example, in a coded bitstream (e.g. using the Video Usability Information (VUI) syntax of H.264/AVC and/or HEVC). A component may be defined as an array or single sample from one of the three sample arrays (luma and two chroma), or an array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame and may be used as encoder input, for example when the source signal is interlaced. Chroma sample arrays may be absent (and hence monochrome sampling may be in use), or chroma sample arrays may be subsampled when compared to luma sample arrays.

Chroma formats may be summarized as follows. In monochrome sampling, there is only one sample array, which may be nominally considered the luma array. In 4:2:0 sampling, each of the two chroma arrays has half the height and half the width of the luma array. In 4:2:2 sampling, each of the two chroma arrays has the same height and half the width of the luma array. In 4:4:4 sampling, when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as largest coding unit (LCU) or coding tree unit (CTU), and the video picture is divided into non-overlapping LCUs.

A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

Each TU can be associated with information describing the prediction error decoding process for the samples within the said TU (including, e.g., DCT coefficient information). It may be signaled at the CU level whether prediction error coding is applied or not for each CU. In the case there is no prediction error residual associated with the CU, it can be considered there are no TUs for the said CU. The division of the image into CUs, and division of CUs into PUs and Tus, may be signaled in the bitstream, allowing the decoder to reproduce the intended structure of these units.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

An intra-coded slice (also called I slice) is a slice that only contains intra-coded blocks. The syntax of an I slice may exclude syntax elements that are related to inter prediction. An inter-coded slice is such where blocks can be intra- or inter-coded. Inter-coded slices may further be categorized into P and B slices, where P slices are such that blocks may be intra-coded or inter-coded but only using uni-prediction, and blocks in B slices may be intra-coded or inter-coded with uni- or bi-prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in the spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO.

In video codecs, the motion information may be indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently, those are typically coded differentially with respect to block specific predicted motion vectors.

In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor.

In addition to predicting the motion vector values, it can be predicted which reference picture(s) are used for motion-compensated prediction, and this prediction information may be represented, for example, by a reference index of previously coded/decoded picture. The reference index is typically predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures, and the used motion field information is signaled among a list of motion field candidate list filled with motion field information of available adjacent/co-located blocks.

In video codecs, the prediction residual after motion compensation may be first transformed with a transform kernel (like DCT) and then coded. The reason for this is that, often, there still exists some correlation among the residual, and transform can in many cases help reduce this correlation and provide more efficient coding.

Video encoders may utilize Lagrangian cost functions to find optimal coding modes (e.g. the desired coding mode for a block and associated motion vectors). This kind of cost function uses a weighting factor λ to tie together the (exact or estimated) image distortion due to lossy coding methods and the (exact or estimated) amount of information that is required to represent the pixel values in an image area:

$$C = D + λ R , \qquad ( 1 )$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account, for example when concluding which prediction sources are available. For example, samples from a neighboring CU may be regarded as unavailable for intra prediction, if the neighboring CU resides in a different slice.

An elementary unit for the output of an H.264/AVC or HEVC encoder and the input of an H. 264/AVC or HEVC decoder, respectively, is a network abstraction layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed, regardless of whether the bytestream format is in use or not. A NAL unit (NALU) may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H. 264/AVC and HEVC, the NAL unit header indicates the type of the NAL unit.

In HEVC, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1−1. The abbreviation TID may be used interchangeably with the TemporalId variable. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream, consisting of VCL NAL units with a particular value of the TemporalId variable and the associated non-VCL NAL units. The nuh_layer_id can be understood as a scalability layer identifier.

NAL units can be categorized into Video Coding Layer (VCL) NAL units and non-VCL NAL units. VCL NAL units may be coded slice NAL units. In HEVC, VCL NAL units contain syntax elements representing one or more CU.

In HEVC, abbreviations for picture types may be defined as follows: trailing (TRAIL) picture, temporal sub-layer access (TSA), step-wise temporal sub-layer access (STSA), random access decodable leading (RADL) picture, random access skipped leading (RASL) picture, broken link access (BLA) picture, instantaneous decoding refresh (IDR) picture, clean random access (CRA) picture.

A random access point (RAP) picture, which may also be referred to as an intra random access point (IRAP) picture in an independent layer, contains only intra-coded slices. An IRAP picture belonging to a predicted layer may contain P, B, and I slices, cannot use inter prediction from other pictures in the same predicted layer, and may use inter-layer prediction from its direct reference layers. In the present version of HEVC, an IRAP picture may be a BLA picture, a CRA picture or an IDR picture. The first picture in a bitstream containing a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that precede the IRAP picture in decoding order. The IRAP picture belonging to a predicted layer and all subsequent non-RASL pictures in decoding order within the same predicted layer can be correctly decoded without performing the decoding process of any pictures of the same predicted layer that precede the IRAP picture in decoding order, when the necessary parameter sets are available when they need to be activated and when the decoding of each direct reference layer of the predicted layer has been initialized. There may be pictures in a bitstream that contain only intra-coded slices that are not IRAP pictures.

A non-VCL NAL unit may be, for example, one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. In HEVC, a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure containing syntax elements that apply to zero or more entire coded video sequences as determined by the content of a syntax element, found in the SPS, referred to by a syntax element found in the PPS, referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present.

Out-of-band transmission, signaling or storage can additionally or alternatively be used for purposes other than tolerance against transmission errors, such as ease of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) may be used in claims and described embodiments to refer to out-of-band transmission, signaling, or storage in a manner that the out-of-band data is associated with the bitstream. The phrase decoding along the bitstream, or alike, may refer to decoding the referred out-of-band data (which may be obtained from out-of-band transmission, signaling, or storage) that is associated with the bitstream.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H. 264/AVC and HEVC contain the syntax and semantics for the specified SEI messages, but no process for handling the messages in the recipient is defined. Consequently, encoders are required to follow the H. 264/AVC standard or the HEVC standard when they create SEI messages, and decoders conforming to the H. 264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In HEVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A coded picture is a coded representation of a picture. In HEVC, a coded picture may be defined as a coded representation of a picture containing all coding tree units of the picture. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units. Said specified classification rule may for example associate pictures with the same output time or picture output count value into the same access unit.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0.

A coded video sequence may be defined as such a sequence of coded pictures in decoding order that is independently decodable and is followed by another coded video sequence or the end of the bitstream or an end of sequence NAL unit.

In HEVC, a coded video sequence may additionally or alternatively (to the specification above) be specified to end when a specific NAL unit, which may be referred to as an end of sequence (EOS) NAL unit, appears in the bitstream and has nuh_layer_id equal to 0.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An HEVC decoder can recognize an intra picture starting an open GOP, because a specific NAL unit type, CRA NAL unit type, may be used for its coded slices.

A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP may start from an IDR picture. In HEVC, a closed GOP may also start from a BLA_W_RADL or a BLA_N_LP picture. An open GOP coding structure is potentially more efficient in the compression compared to a closed GOP coding structure, due to a larger flexibility in selection of reference pictures.

A structure of pictures (SOP) may be defined as one or more coded pictures consecutive in decoding order, in which the first coded picture in decoding order is a reference picture at the lowest temporal sub-layer and no coded picture except, potentially, the first coded picture in decoding order is a RAP picture. All pictures in the previous SOP precede in decoding order all pictures in the current SOP, and all pictures in the next SOP succeed in decoding order all pictures in the current SOP. A SOP may represent a hierarchical and repetitive inter prediction structure. The term group of pictures (GOP) may sometimes be used interchangeably with the term SOP, and having the same semantics as the semantics of SOP.

A decoded picture buffer (DPB) may be used in the encoder and/or in the decoder. There are two reasons to buffer decoded pictures: for references in inter prediction, and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H. 264/AVC and HEVC, two reference picture lists (reference picture list 0 and reference picture list 1) are generated for each bi-predictive (B) slice, and one reference picture list (reference picture list 0) is formed for each inter-coded (P) slice.

A reference picture list, such as the reference picture list 0 and the reference picture list 1, may be constructed in two steps. First, an initial reference picture list is generated. The initial reference picture list may be generated, for example, on the basis of frame_num, picture order count (POC), temporal_id, or information on the prediction hierarchy such as a GOP structure, or any combination thereof. Second, the initial reference picture list may be reordered by reference picture list reordering (RPLR) syntax, also known as reference picture list modification syntax structure, which may be contained in slice headers. The initial reference picture lists may be modified through the reference picture list modification syntax structure, where pictures in the initial reference picture lists may be identified through an entry index to the list.

Many coding standards, including H.264/AVC and HEVC, may have decoding process to derive a reference picture index to a reference picture list, which may be used to indicate which one of the multiple reference pictures is used for inter prediction for a particular block. A reference picture index may be coded by an encoder into the bitstream in some inter coding modes, or it may be derived (by an encoder and a decoder), for example using neighboring blocks, in some other inter coding modes.

Several candidate motion vectors may be derived for a single prediction unit. For example, motion vector prediction HEVC includes two motion vector prediction schemes, namely the advanced motion vector prediction (AMVP) and the merge mode. In the AMVP or the merge mode, a list of motion vector candidates is derived for a PU. There are two kinds of candidates: spatial candidates and temporal candidates, where temporal candidates may also be referred to as temporal motion vector prediction (TMVP) candidates.

A candidate list derivation may be performed, for example, as follows; it should be understood that other possibilities may exist for candidate list derivation. If the occupancy of the candidate list is not at a maximum, the spatial candidates are included in the candidate list first if they are available and not already in the candidate list. After that, if occupancy of the candidate list is not yet at the maximum, a temporal candidate is included in the candidate list. If the number of candidates still does not reach the maximum allowed number, the combined bi-predictive candidates (for B slices) and a zero motion vector are added in. After the candidate list has been constructed, the encoder decides the final motion information from candidates, for example based on a rate-distortion optimization (RDO) decision, and encodes the index of the selected candidate into the bitstream. Likewise, the decoder decodes the index of the selected candidate from the bitstream, constructs the candidate list, and uses the decoded index to select a motion vector predictor from the candidate list.

A motion vector anchor position may be defined as a position (e.g. horizontal and vertical coordinates) within a picture area relative to which the motion vector is applied. A horizontal offset and a vertical offset for the anchor position may be given in the slice header, slice parameter set, tile header, tile parameter set, or the like.

An example encoding method taking advantage of a motion vector anchor position may comprise: encoding an input picture into a coded constituent picture; reconstructing, as a part of said encoding, a decoded constituent picture corresponding to the coded constituent picture; encoding a spatial region into a coded tile, the encoding comprising: determining a horizontal offset and a vertical offset indicative of a region-wise anchor position of the spatial region within the decoded constituent picture; encoding the horizontal offset and the vertical offset; determining that a prediction unit at position of a first horizontal coordinate and a first vertical coordinate of the coded tile is predicted relative to the region-wise anchor position, wherein the first horizontal coordinate and the first vertical coordinate are horizontal and vertical coordinates, respectively, within the spatial region; indicating that the prediction unit is predicted relative to a prediction-unit anchor position that is relative to the a region-wise anchor position; deriving prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

An example decoding method wherein a motion vector anchor position is used may comprise: decoding a coded tile into a decoded tile, the decoding comprising: decoding a horizontal offset and a vertical offset; decoding an indication that a prediction unit at position of a first horizontal coordinate and a first vertical coordinate of the coded tile is predicted relative to a prediction-unit anchor position that is relative to the horizontal and vertical offset; deriving a prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

Features as described herein may generally relate to scalable video coding. Scalable video coding may refer to a coding structure where one bitstream can contain multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on, for example, the network characteristics or processing capabilities of the receiver. A meaningful decoded representation can be produced by decoding only certain parts of a scalable bit stream. A scalable bitstream may consist of a “base layer” providing the lowest quality video available, and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e. the frame rate), the spatial resolution, or simply the quality of the video content represented by another layer or part thereof. Each layer, together with all its dependent layers, is one representation of the video signal, for example, at a certain spatial resolution, temporal resolution and quality level. In the present disclosure, a scalable layer together with all of its dependent layers is referred to as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: base layer pictures are coded at a lower quality than enhancement layer pictures, which may be achieved for example using a greater quantization parameter value (i.e. a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: base layer pictures are coded at a lower resolution (i.e. have fewer samples) than enhancement layer pictures. Spatial scalability and quality scalability, particularly its coarse-grain scalability type, may sometimes be considered the same type of scalability.
View scalability, which may also be referred to as multiview coding. The base layer represents a first view, whereas an enhancement layer represents a second view. A view may be defined as a sequence of pictures representing one camera or viewpoint. It may be considered that in stereoscopic or two-view video, one video sequence or view is presented for the left eye while a parallel view is presented for the right eye.
Depth scalability, which may also be referred to as depth-enhanced coding. A layer or some layers of a bitstream may represent texture view(s), while other layer or layers may represent depth view(s).

It should be understood that many of the scalability types may be combined and applied together.

The term “layer” may be used in the context of any type of scalability, including view scalability and depth enhancements. An enhancement layer may refer to any type of an enhancement, such as SNR, spatial, multiview, and/or depth enhancement. A base layer may refer to any type of a base video sequence, such as a base view, a base layer for SNR/spatial scalability, or a texture base view for depth-enhanced video coding.

A sender, a gateway, a client, or another entity may select the transmitted layers and/or sub-layers of a scalable video bitstream. The terms layer extraction, extraction of layers, or layer down-switching may refer to transmitting fewer layers than what is available in the bitstream received by the sender, the gateway, the client, or another entity. Layer up-switching may refer to transmitting additional layer(s) compared to those transmitted prior to the layer up-switching by the sender, the gateway, the client, or another entity, i.e. restarting the transmission of one or more layers whose transmission was ceased earlier in layer down-switching. Similarly to layer down-switching and/or up-switching, the sender, the gateway, the client, or another entity may perform down- and/or up-switching of temporal sub-layers. The sender, the gateway, the client, or another entity may also perform both layer and sub-layer down-switching and/or up-switching. Layer and sub-layer down-switching and/or up-switching may be carried out in the same access unit or alike (i.e. virtually simultaneously) or may be carried out in different access units or alike (i.e. virtually at distinct times).

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture, similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g. sample values or motion vectors) of reference pictures from a different layer than the layer of the current picture (being encoded or decoded). Many types of inter-layer prediction exist and may be applied in a scalable video encoder/decoder. The available types of inter-layer prediction may, for example, depend on the coding profile according to which the bitstream or a particular layer within the bitstream is being encoded or, when decoding, the coding profile that the bitstream or a particular layer within the bitstream is indicated to conform to. Alternatively or additionally, the available types of inter-layer prediction may depend on the types of scalability or the type of a scalable codec or video coding standard amendment (e.g. SHVC, MV-HEVC, or 3D-HEVC) being used.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer, but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

Similarly to MVC, in MV-HEVC, inter-view reference pictures can be included in the reference picture list(s) of the current picture being coded or decoded. SHVC uses multi-loop decoding operation (unlike the SVC extension of H.264/AVC). SHVC may be considered to use a reference index based approach, i.e. an inter-layer reference picture can be included in one or more reference picture lists of the current picture being coded or decoded (as described above).

For the enhancement layer coding, the concepts and coding tools of HEVC base layer may be used in SHVC, MV-HEVC, and/or alike. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or alike codec.

Video coding specifications may contain a set of constraints for associating data units (e.g. NAL units in H.264/AVC or HEVC) into access units. These constraints may be used to conclude access unit boundaries from a sequence of NAL units. For example, the following is specified in the HEVC standard:
An access unit consists of one coded picture with nuh_layer_id equal to 0, zero or more VCL NAL units with nuh_layer_id greater than 0 and zero or more non-VCL NAL units.
Let firstBlPicNalUnit be the first VCL NAL unit of a coded picture with nuh_layer_id equal to 0. The first of any of the following NAL units preceding firstBlPicNalUnit and succeeding the last VCL NAL unit preceding firstBlPicNalUnit, if any, specifies the start of a new access unit: access unit delimiter NAL unit with nuh_layer_id equal to 0 (when present); VPS NAL unit with nuh_layer_id equal to 0 (when present); SPS NAL unit with nuh_layer_id equal to 0 (when present); PPS NAL unit with nuh_layer_id equal to 0 (when present); Prefix SEI NAL unit with nuh_layer_id equal to 0 (when present); NAL units with nal_unit_type in the range of RSV_NVCL41 . . . RSV_NVCL44 with nuh_layer_id equal to 0 (when present); NAL units with nal_unit_type in the range of UNSPEC48 . . . UNSPEC55 with nuh_layer_id equal to 0 (when present).

The first NAL unit preceding firstBlPicNalUnit and succeeding the last VCL NAL unit preceding firstBlPicNalUnit, if any, can only be one of the above-listed NAL units. When there is none of the above NAL units preceding firstBlPicNalUnit and succeeding the last VCL NAL preceding firstBlPicNalUnit, if any, firstBlPicNalUnit starts a new access unit.

Access unit boundary detection may be based on, but may not be limited to, one or more of the following:
Detecting that a VCL NAL unit of a base-layer picture is the first VCL NAL unit of an access unit, for example on the basis that: the VCL NAL unit includes a block address or alike that is the first block of the picture in decoding order; and/or the picture order count, picture number, or similar decoding or output order or timing indicator differs from that of the previous VCL NAL unit(s).
Having detected the first VCL NAL unit of an access unit, concluding based on pre-defined rules, for example, based on nal_unit_type, which non-VCL NAL units that precede the first VCL NAL unit of an access unit and succeed the last VCL NAL unit of the previous access unit in decoding order belong to the access unit.

The versatile video coding (VVC) includes new coding tools compared to HEVC or H.264/AVC. These coding tools are related to, for example, intra prediction; inter-picture prediction; transform, quantization and coefficients coding; entropy coding; in-loop filter; screen content coding; 360-degree video coding; high-level syntax and parallel processing. Some of these tools are briefly described in the following:
Intra prediction: 67 intra mode with wide angles mode extension; block size and mode dependent 4 tap interpolation filter; position dependent intra prediction combination (PDPC); cross component linear model intra prediction (CCLM); multi-reference line intra prediction; intra sub-partitions; weighted intra prediction with matrix multiplication.
Inter-picture prediction: block motion copy with spatial, temporal, history-based, and pairwise average merging candidates; affine motion inter prediction; sub-block based temporal motion vector prediction; adaptive motion vector resolution; 8×8 block-based motion compression for temporal motion prediction; high precision ( 1/16 pel) motion vector storage and motion compensation with 8-tap interpolation filter for luma component and 4-tap interpolation filter for chroma component; triangular partitions; combined intra and inter prediction; merge with motion vector difference (MVD) (MMVD); symmetrical MVD coding; bi-directional optical flow; decoder side motion vector refinement; bi-prediction with CU-level weight.
Transform, quantization and coefficients coding: multiple primary transform selection with DCT2, DST7 and DCT8; secondary transform for low frequency zone; sub-block transform for inter predicted residual; dependent quantization with max QP increased from 51 to 63; transform coefficient coding with sign data hiding; transform skip residual coding.
Entropy coding: arithmetic coding engine with adaptive double windows probability update.
In loop filter: in-loop reshaping; deblocking filter with strong longer filter; sample adaptive offset; adaptive loop filter.
Screen content coding: current picture referencing with reference region restriction.
360-degree video coding: horizontal wrap-around motion compensation.
High-level syntax and parallel processing: reference picture management with direct reference picture list signaling; tile groups with rectangular shape tile groups.

In VVC, each picture may be partitioned into coding tree units (CTUs) similar to HEVC. A CTU may be split into smaller CUs using quaternary tree structure. Each CU may be partitioned using quad-tree and nested multi-type tree, including ternary and binary split. There are specific rules to infer partitioning in picture boundaries. The redundant split patterns are disallowed in nested multi-type partitioning.

In some video coding schemes, such as HEVC and VVC, a picture is divided into one or more tile rows and one or more tile columns. The partitioning of a picture to tiles forms a tile grid that may be characterized by a list of tile column widths and a list of tile row heights. A tile may be required to contain an integer number of elementary coding blocks, such as CTUs in HEVC and VVC. Consequently, tile column widths and tile row heights may be expressed in the units of elementary coding blocks, such as CTUs in HEVC and VVC.

A tile may be defined as a sequence of elementary coding blocks, such as CTUs in HEVC and VVC, that covers one “cell” in the tile grid (i.e. a rectangular region of a picture). Elementary coding blocks, such as CTUs, may be ordered in the bitstream in raster scan order within a tile.

Some video coding schemes may allow further subdivision of a tile into one or more bricks, each consisting of a number of CTU rows within the tile. A tile that is not partitioned into multiple bricks may also be referred to as a brick. However, a brick that is a true subset of a tile is not referred to as a tile.

In some video coding schemes, such as H. 264/AVC, HEVC and VVC, a coded picture may be partitioned into one or more slices. A slice may be decodable independently of other slices of a picture and hence a slice may be considered as a preferred unit for transmission. In some video coding schemes, such as H. 264/AVC, HEVC, and VVC, a video coding layer (VCL) NAL unit contains exactly one slice.

A slice may comprise an integer number of elementary coding blocks, such as CTUs in HEVC or VVC.

In some video coding schemes, such as VVC, a slice contains an integer number of tiles of a picture or an integer number of CTU rows of a tile.

In some video coding schemes, two modes of slices may be supported, namely the raster-scan slice mode and the rectangular slice mode. In the raster-scan slice mode, a slice contains a sequence of tiles in a tile raster scan of a picture. In the rectangular slice mode, a slice contains an integer number of tiles of a picture or an integer number of CTU rows of a tile that collectively form a rectangular region of the picture.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, a picture header (PH) NAL unit, an end of sequence NAL unit, an end of bitstream NAL unit, or a filler data NAL unit. Some non-VCL NAL units, such as parameter sets and picture headers, may be needed for the reconstruction of decoded pictures, whereas many of the other non-VCL NAL units might not be necessary for the reconstruction of decoded sample values.

Some coding formats specify parameter sets that may carry parameter values needed for the decoding or reconstruction of decoded pictures. Some examples of different types of parameter sets are now briefly described. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on a picture basis. In VVC, an Adaptation Parameter Set (APS) may comprise parameters for decoding processes of different types, such as adaptive loop filtering or luma mapping with chroma scaling.

A parameter set may be activated when it is referenced e.g., through its identifier. For example, a header of an image segment, such as a slice header, may contain an identifier of the PPS that is activated for decoding the coded picture containing the image segment. A PPS may contain an identifier of the SPS that is activated, when the PPS is activated. An activation of a parameter set of a particular type may cause the deactivation of the previously active parameter set of the same type.

Instead of or in addition to parameter sets at different hierarchy levels (e.g. sequence and picture), video coding formats may include header syntax structures, such as a sequence header or a picture header. A sequence header may precede any other data of the coded video sequence in the bitstream order. A picture header may precede any coded video data for the picture in the bitstream order.

Video coding specifications may enable the use of supplemental enhancement information (SEI) messages or alike. Some video coding specifications include SEI NAL units, and some video coding specifications contain both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output t timing, post-processing of decoded pictures, rendering, error detection, error concealment, and resource reservation.

Several SEI messages are specified in H. 264/AVC, H.265/HEVC, H.266/VVC, and H.274/VSEI standards, and the user data SEI messages enable organizations and companies to specify SEI messages for specific use. The standards may contain the syntax and semantics for the specified SEI messages, but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Features as described herein may generally relate to a bitstream. A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and is the last NAL unit of the bitstream.

A coded video sequence (CVS) may be defined as such a sequence of coded pictures in decoding order that is independently decodable and is followed by another coded video sequence or the end of the bitstream.

The subpicture feature of VVC allows for partitioning of the VVC bitstream in a flexible manner as multiple rectangles representing subpictures, where each subpicture comprises one or more slices. In other words, a subpicture may be defined as a rectangular region of one or more slices within a picture, wherein the one or more slices are complete. Consequently, a subpicture consists of one or more slices that collectively cover a rectangular region of a picture. The slices of a subpicture may be required to be rectangular slices.

In VVC, the feature of subpictures enables efficient extraction of subpicture(s) from one or more bitstream and merging the extracted subpictures to form another bitstream without excessive penalty in compression efficiency and without modifications of VCL NAL units (i.e. slices).

The use of subpictures in a coded video sequence (CVS), however, requires appropriate configuration of the encoder and other parameters such as SPS/PPS and so on. In VVC, a layout of partitioning of a picture to subpictures may be indicated in and/or decoded from an SPS. A subpicture layout may be defined as a partitioning of a picture to subpictures. In VVC, the SPS syntax indicates the partitioning of a picture to subpictures by providing for each subpicture syntax elements indicative of: the x and y coordinates of the top-left corner of the subpicture, the width of the subpicture, and the height of the subpicture, in CTU units. One or more of the following properties may be indicated (e.g. by an encoder) or decoded (e.g. by a decoder) or inferred (e.g. by an encoder and/or a decoder) for the subpictures collectively or per each subpicture individually: i) whether or not a subpicture is treated like a picture in the decoding process (or equivalently, whether or not subpicture boundaries are treated like picture boundaries in the decoding process); in some cases, this property excludes in-loop filtering operations, which may be separately indicated/decoded/inferred; ii) whether or not in-loop filtering operations are performed across the subpicture boundaries. When a subpicture is treated like a picture in the decoding process, any references to sample locations outside the subpicture boundaries are saturated to be within the subpicture boundaries. This may be regarded being equivalent to padding samples outside subpicture boundaries with the boundary sample values for decoding the subpicture. Consequently, motion vectors may be allowed to cause references outside subpicture boundaries in a subpicture that is extractable.

An independent subpicture (a.k.a. an extractable subpicture) may be defined as a subpicture i) with subpicture boundaries that are treated as picture boundaries and ii) without loop filtering across the subpicture boundaries. A dependent subpicture may be defined as a subpicture that is not an independent subpicture.

In video coding, an isolated region may be defined as a picture region that is allowed to depend only on the corresponding isolated region in reference pictures and does not depend on any other picture regions in the current picture or in the reference pictures. The corresponding isolated region in reference pictures may be, for example, the picture region that collocates with the isolated region in a current picture. A coded isolated region may be decoded without the presence of any picture regions of the same coded picture.

A VVC subpicture with boundaries treated like picture boundaries may be regarded as an isolated region.

A motion-constrained tile set (MCTS) is a set of tiles such that the inter prediction process is constrained in encoding such that no sample value outside the MCTS, and no sample value at a fractional sample position that is derived using one or more sample values outside the motion-constrained tile set, is used for inter prediction of any sample within the motion-constrained tile set. Additionally, the encoding of an MCTS is constrained in a manner that no parameter prediction takes inputs from blocks outside the MCTS. For example, the encoding of an MCTS is constrained in a manner that motion vector candidates are not derived from blocks outside the MCTS. In HEVC, this may be enforced by turning off temporal motion vector prediction of HEVC, or by disallowing the encoder to use the temporal motion vector prediction (TMVP) candidate or any motion vector prediction candidate following the TMVP candidate in a motion vector candidate list for prediction units located directly left of the right tile boundary of the MCTS, except the last one at the bottom right of the MCTS.

In general, an MCTS may be defined to be a tile set that is independent of any sample values and coded data, such as motion vectors, that are outside the MCTS. An MCTS sequence may be defined as a sequence of respective MCTSs in one or more coded video sequences or alike. In some cases, an MCTS may be required to form a rectangular area. It should be understood that, depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets. An MCTS is an example of an isolated region.

Features as described herein may generally relate to VVC. The VVC has a functionality of subpictures which may be regarded to improve the motion constrained tiles. VVC support for real-time conversational and low latency use cases will be important to fully exploit the functionality and end user benefit with modern networks (e.g. ultra-reliable low-latency communication (ULLRC) 5G networks, over-the-top (OTT) delivery, etc.). VVC encoding and decoding is computationally complex. With increasing computational complexity, the end-user devices consuming the content are heterogeneous, for example devices supporting single decoding instances to devices supporting multiple decoding instances and more sophisticated devices having multiple decoders. Consequently, the system carrying the payload should be able to support a variety of scenarios for scalable deployments. There has been rapid growth in the resolution (e.g. 8K) of the video consumed via consumer electronics (CE) devices (e.g. TVs, mobile devices) which can benefit with the ability to execute multiple parallel decoders. One example use case can be parallel decoding for low latency unicast or multicast delivery of 8K VVC encoded content.

The AV1 codec supports input video signals in the 4:0:0 (monochrome), 4:2:0, 4:2:2, and 4:4:4 formats. The allowed pixel representations are 8, 10, and 12 bit. The AV1 codec operates on pixel blocks. Each pixel block is processed in a predictive-transform coding scheme, where the prediction comes from either intraframe reference pixels, interframe motion compensation, or some combinations of the two. The residuals undergo a 2-D unitary transform to further remove the spatial correlations, and the transform coefficients are quantized. Both the prediction syntax elements and the quantized transform coefficient indexes are then entropy coded using arithmetic coding. There are three optional in-loop postprocessing filter stages to enhance the quality of the reconstructed frame for reference by subsequent coded frames. A normative film grain synthesis unit is also available to improve the perceptual quality of the displayed frames.

The AV1 bitstream is packetized into open bitstream units (OBUs). An ordered sequence of OBUs is fed into the AV1 decoding process, where each OBU comprises a variable length string of bytes. An OBU contains a header and a payload. The header identifies the OBU type and specifies the payload size. The OBU types may include the following.

1) Sequence header contains information that applies to the entire sequence, for example sequence profile (see Section VIII) and whether to enable certain coding tools.

2) Temporal delimiter indicates the frame presentation time stamp. All displayable frames following a temporal delimiter OBU will use this time stamp, until the next temporal delimiter OBU arrives. A temporal delimiter and its subsequent OBUs of the same time stamp are referred to as a temporal unit. In the context of scalable coding, the compression data associated with all representations of a frame at various spatial and fidelity resolutions will be in the same temporal unit.

3) Frame header sets up the coding information for a given frame, including signaling inter or intraframe type, indicating the reference frames, and signaling probability model update method.

4) Tile group contains the tile data associated with a frame. Each tile can be independently decoded. The collective reconstructions form the reconstructed frame after potential loop filtering.

5) Frame contains the frame header and tile data. The frame OBU is largely equivalent to a frame header OBU and a tile group OBU, but allows less overhead cost.

6) Metadata carries information, such as high dynamic range, scalability, and timecode.

7) Tile list contains tile data similar to a tile group OBU. However, each tile here has an additional header that indicates its reference frame index and position in the current frame. This allows the decoder to process a subset of tiles and display the corresponding part of the frame, without the need to fully decode all the tiles in the frame.

MPEG-5 Part 2 Low Complexity Enhancement Video Coding (LCEVC) is published as ISO/IEC 23094-2. LCEVC works by encoding a lower resolution (and potentially also lower bit depth) version of a source video using any existing codec (the “base codec”) and then coding the differences between the lower resolution video and the full resolution source, up to mathematically lossless coding if needed, using a different compression method (the “enhancement”). This enhancement is achieved by a combination of processing an input video at a lower resolution with an existing single-layer codec, and using a simple and small set of highly specialized tools to correct impairments, upscale, and add details to the processed video.

At the encoder, the encoding process to create an LCEVC conformant bitstream can be depicted in three major parts/steps. Firstly, in the basic codec, the input sequence is fed into two consecutive non-normative downscalers and is processed according to the chosen scaling modes. Any combination of the three available options (2-dimensional scaling, 1-dimensional scaling in the horizontal direction only or no scaling) can be used. The output then invokes the base codec, which produces a base bitstream according to its own specification. This encoded base can be included as part of the LCEVC bitstream. For enhancement sub-layer 1, the reconstructed base picture may be upscaled to undo the downscaling process and is then subtracted from the first-order downscaled input sequence in order to generate the sub-layer 1 (L-1) residuals. These residuals form the starting point of the encoding process of the first enhancement sub-layer. A number of coding tools, which will be described further in the following section, process the input and generate entropy encoded quantized transform coefficients. For enhancement sub-layer 2, as a last step of the encoding process, the enhancement data for sub-layer 2 (L-2) needs to be generated. In order to create the residuals, the coefficients from sub-layer 1 are processed by an in-loop LCEVC decoder to achieve the corresponding reconstructed picture. Depending on the chosen scaling mode, the reconstructed picture is processed by an upscaler. Finally, the residuals are calculated by a subtraction of f the input sequence and the upscaled reconstruction. Similar to sub-layer 1, the samples are processed by a few coding tools. In addition, a temporal prediction can be applied on the transform coefficients in order to achieve a better removal of redundant information. The entropy encoded quantized transform coefficients of sub-layer 2, as well as a temporal layer specifying the use of the temporal prediction on a block basis, are included in the LCEVC bitstream.

At the decoder, for the creation of the output sequence, the decoder analyses the LCEVC conformant bitstream. The process can again be divided into three parts/steps. In the base codec, in order to generate the decoded base picture (Layer 0), the base decoder is fed with the extracted base bitstream. According to the chosen scaling mode in the configuration, this reconstructed picture might be upscaled and is afterwards called preliminary intermediate picture. Following the base layer, the enhancement part needs to be decoded. Firstly, the coefficients belonging to enhancement sub-layer 1 are decoded using the inverse tools of the encoding process. Additionally, an L-1 filter might be applied in order to smooth the boundaries of a transform block. The output is then referred to as Enhancement Sub-Layer 1 and is added to the preliminary intermediate picture, which results in the Combined Intermediate Picture. Again, depending on the scaling mode, an upscaler might be applied, and the resulting preliminary output picture has then the same dimensions as the overall output picture. As a final step, the second enhancement sub-layer is decoded. According to the temporal layer, a temporal prediction might be applied to the dequantized transform coefficients. This enhancement sub-layer 2 is then added to the preliminary output picture to form the combined output picture as a final output of the decoding process.

Features as described herein may generally relate to bitstream structure. The LCEVC bitstream contains a base layer, which may be at a lower resolution, and an enhancement layer consisting of up to two sub-layers. This subsection briefly explains the structure of this bitstream and how the information can be extracted. While the base layer can be created using any video encoder and is not specified further in the LCEVC specification, the enhancement layer is expected to follow the structure as specified. Similar to other MPEG codecs, the syntax elements are encapsulated in network abstraction layer (NAL) units, which also help synchronize the enhancement layer information with the base layer decoded information. Depending on the position of the frame within a group of pictures (GOP), additional data specifying the global configuration and controlling the decoder may be present. The data of one enhancement picture is encoded into several chunks. These data chunks are hierarchically organized. For each processed plane (nPlanes), up to two enhancement sub-layers (nLevels) are extracted. Each of them again unfolds into numerous coefficient groups of entropy encoded transform coefficients. The amount depends on the chosen type of transform (nLayers). Additionally, if the temporal prediction is used, for each processed plane an additional chunk with temporal data for enhancement sub-layer 2 is present.

MPEG-5 LCEVC has some similarities with a scalable codec (i.e. spatial scalability thanks to the upsampler) but it is also substantially different, for at least the following reasons.

Generally, in a scalable codec, the base layer is encoded with the same standard of the enhancement layer. As specified in the description, LCEVC is codec agnostic. The base layer used in LCEVC can be any codec. This particular feature allows LCEVC to be used with any standard, such as H.264/AVC or H. 266/VVC, and also with any other video codec (e.g. AV1, VP8, VP9 etc.).

The MPEG-5 structure is LCEVC using simple tools specifically designed for the sparse nature of the residual data which allow to keep the complexity low and limit the overhead associated with the enhancement layers, a common problem of scalable codecs. This makes it possible to have a software version of the MPEG-5 LCEVC that can run on existing hardware and on top of existing base codec with no need to develop a specific hardware for it. As a consequence, the base codec can work more efficiently and faster given the ability of LCEVC to work with a base codec running at a quarter of the resolution.

Differently to most of scalable codecs, MPEG-5 LCEVC provides two levels of enhancement that can be applied at different stages or resolutions. Each level has its own independent quantization module and sublayer of the bitstream that can easily be decoupled from the other. This also allows bitrate allocation flexibility to cope with different types of content. It may be noted that MPEG-5 LCEVC offers up to two cascade scaling processes in order to further improve the efficiency of the base layer. Each scaler can be user defined, along the following degrees of freedom: kernel size, type of upscaling (i.e. which sub-layer, L-1 or L-2), and kernel values. MPEG-5 LCEVC offers 4 normative upsamplers and one 4 taps user defined kernel. Scalable codecs are generally offering only one fixed scaling engine, and it is not programmable.

MPEG-5 LCEVC can handle different bit depths, up to 14 bits per pixel in the main profile. The standard allows the base layer to work on a different bit depth compared the input signal one. This operation can effectively enhance a base layer working at a lower bit depth to a higher one contributing to maintain the fidelity of the input signal. An example of this application is delivering high dynamic range (HDR) with technologies that cannot deliver more than 8-bit per color component, like AVC High Profile.

Features as described herein may generally relate to resource identification. A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

Features described herein may generally relate to transmission/storage of coded/decoded information. In many video communication or transmission systems, transport mechanisms, and multimedia container file formats, there are mechanisms to transmit or store a scalability layer separately from another scalability layer of the same bitstream, for example to transmit or store the base layer separately from the enhancement layer(s). It may be considered that layers are stored in or transmitted through separate logical channels. For example, in ISOBMFF, the base layer can be stored as a track and each enhancement layer can be stored in another track, which may be linked to the base-layer track using so-called track references.

The document M61206 titled “Single-track carriage and storage of MPEG-5 LCEVC possible solutions” describes carrying a complete set composed by base and LCEVC bitstreams via an SEI approach (insert LCEVC NALUs as SEI messages in the base NALU stream) or via an interleaved NALUs approach (insert LCEVC NALUs as interleaved NALUs within the base NALU stream). When carrying a LCEVC bitstream via an SEI approach, a new SEI message may be defined for LCEVC, and may be referenced as a new payload type in each of the base layer video coding specifications. Alternatively, an ITU-T T.35 SEI message, a user data registered by Rec. ITU-T T.35 SEI message, or alike may be used to carry LCEVC NALU(s). However, an SEI approach may not be a viable option, as this would need a reader to maintain a context for each MPEG standard. It is also required that the specification text needs to be updated when support for newer standards is added. Additionally, it is not a good practice to carry NALU payload in an SEI message, as traditionally SEI messages are used to carry information, which may be used after decoding of the NALUs of the base standard. Having NALUs in SEI message can make them heavy to process.

An alternative to carrying a LCEVC bitstream via interleaved NALUs may be to reserve, within the base video coding standard specifications, several NALUs for LCEVC. There would need to be at least two NALU reserved for LCEVC.

As discussed above, the dual-track approach is critical to support various use cases, including transporting a base bitstream and an enhancement bitstream in two separate physical channels (e.g. the base bitstream via an over-the-air channel and the enhancement bitstream via a broadband channel). For example, the following case is to be supported by the next-generation TV3.0 system to be deployed in Brazil from 2024—in that standard, the base bitstream would be VVC and the enhancement bitstream would be LCEVC.

However, during the technical analysis of the dual-track approach, there have been comments on the opportunity to consider and develop a technical solution to carry the “complete set” represented by a base bitstream plus an LCEVC bitstream as a single-track in terms of MPEG2 TS PID or MPEG4 FF track. This is because there are many commercial player implementations, particularly in the streaming space, where a player can only support a single stream playback. Moreover, the use of a single-track approach could simplify the design of players. With the single-track approach, the NAL units from LCEVC and the base bitstream live in the same sample of the track. This would require that the decoder configuration information needed to decode both the LCEVC and the base bitstream be present in the same track under a given sample entry. Additionally, it is also required to map the NALUs of a sample to a specific decoder configuration record. Different video coding formats have different NAL unit header structures. Different video coding formats have different allocation of nal_unit_type values. Some video coding formats are not based on NAL units.

In case of V-DMC, the new bitstreams (V3C non-video components) that base mesh and carry arithmetic coded displacements may require definition of a new track type(s), and changes to the architecture regarding how V3C content is stored in ISOBMFF. This may consequently affect how dynamic adaptive streaming over HTTP (DASH) or other transport level tools are used to deliver V3C. By using one track to store atlas, common atlas, base mesh, and displacement information, the ISOBMFF architecture may be maintained, and transport systems delivery may not require any changes.

In an example embodiment, a first encoded bitstream encoded with a first coding standard/method, and a second encoded bitstream(s) encoded with a second coding standard/method may be used as input to produce an encapsulated file with one track. The one track may comprise the first encoded bitstream and the second encoded bitstream(s). The file may also include an indication that the first encoded bitstream is encapsulated in the samples of the track, and the second encoded bitstream is encapsulated in the sample auxiliary information of the track.

In an example embodiment, an encapsulated file with at least one track may be used as input to produce a first encoded bitstream encoded with a first coding standard/method, and a second encoded bitstreams encoded with second coding standard/method. The at least one track may comprise a first encoded bitstream and a second encoded bitstream(s). The file may also include an indication that the first encoded bitstream is encapsulated in the samples of the track and the second encoded bitstream is encapsulated in the sample auxiliary information of the track.

The requirement is to carry both the LCEVC bitstream and the base bitstream in the same track in a backward compatible manner. One way to achieve backward compatibility is by reusing the existing sample entry of the base track. In an example embodiment, the base sample entry may be reused. In an example, an AVC base codec may be encapsulated in a track with a sample entry with 4cc ‘avc1’. Any other sample entry for AVC codec as defined in ISO/IEC 14996-15 may be used.

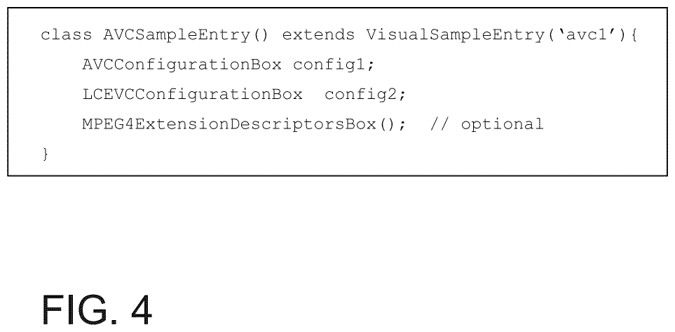

The sample entry of the base track may contain one or more ConfigurationBoxes. One of the ConfigurationBox in the sample entry of the base track contains DecoderConfigurationRecord for the base codec. One or more of the ConfigurationBoxes in the sample entry of the base track contains DecoderConfigurationRecord for the one or more respective additional enhancement codecs (for example LCEVC). An example syntax structure of AVC track with ‘avc1’ sample entry containing both AVC and LCEVC ConfigurationBoxes are shown in FIG. 4.

In an example embodiment, the samples of the base track may contain the data related to the base codec, and the data related to second codec (for example, LCEVC). The data related to the second codec may be carried as part of the sample auxiliary information related to the samples of the base track.

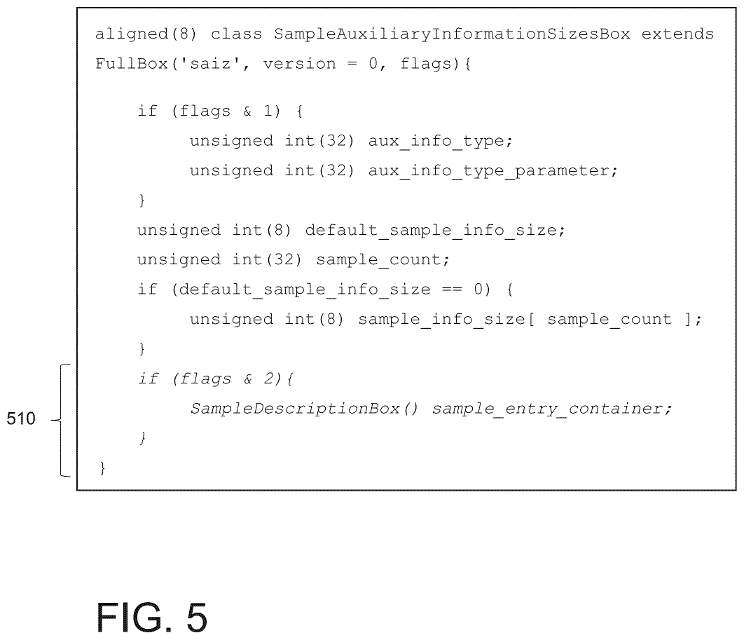

In an example embodiment, the SampleAuxiliaryInformationSizesBox may be extended. The extension may comprise information of a sample entry, which may, for example, include one or more ConfigurationBoxes. For example, the syntax of FIG. 5 may be used, where the extension is indicated with italics at 510.

The sample_entry_container may include a sample entry that specifies the format of the sample auxiliary information.

It is to be understood that the syntax above is merely an example. Example embodiments may be similarly realized with other syntax, such as extending the SampleAuxiliaryInformationSizesBox directly with an instance of an SampleEntry, containing a single SampleEntry in a newly defined box that is used to extend SampleAuxiliaryInformationSizesBox, or extending SampleAuxiliaryInformationSizesBox with a decoding configuration record structure.

In an example embodiment, aux_info_type may be set equal to the sample entry 4CC. In an example embodiment, a file reader may interpret aux_info_type to indicate a sample entry 4CC, when sample_entry_container is present in SampleAuxiliaryInformationSizesBox.

In an example embodiment, aux_info_type may be set equal to the media handler 4CC, and aux_info_type_parameter may be set equal to the sample entry 4CC. In an example embodiment, a file reader may interpret aux_info_type to indicate a media handler 4CC and aux_info_type_parameter to indicate a sample entry 4CC, when sample_entry_container is present in SampleAuxiliaryInformationSizesBox.

In an example embodiment, a sample entry 4CC in the embodiments above may be allowed to indicate a transformed media track, such as an encrypted media track or a restricted media track. In this case, the one or more sample entries carried in the SampleAuxiliaryInformationSizesBox may include the boxes implied by the transformation. In an example embodiment, a file writer may write boxes for transformed media track processing in one or more entries sample carried in the SampleAuxiliaryInformationSizesBox. In an example embodiment, a file reader may parse boxes for transformed media track processing from one more sample or entries in the carried SampleAuxiliaryInformationSizesBox. The file reader or a player may subsequently process the sample auxiliary information according to the boxes for transformed media track processing. For example, the file reader or the player may decrypt the sample auxiliary information.

In an example embodiment, a new sample auxiliary information may be defined. In an example embodiment, the new sample auxiliary information may be defined as LCEVC sample auxiliary information, or the additional codec sample auxiliary information, or the enhancement codec sample auxiliary information. Any other name may be used which indicates the presence of coded streams in the sample auxiliary data.

In an example embodiment, the coded streams may be from codecs which may be different from the one indicated by the sample entry of the track to which the sample and its sample auxiliary data belong to. For example, the sample entry of the track may indicate that it is a AVC1 track, whereas the coded streams may be encoded using LCEVC.

In an alternate example embodiment, the coded streams may be from the same codecs (but different layers of a multi-layer elementary stream) which may be indicated by the sample entry of the track to which the sample and its sample auxiliary data belong to.

Example embodiments are described by using LCEVC as an example codec whose coded streams are present together with the coded stream of a base codec. However, the example embodiments are not limited to LCEVC coded streams, but generally apply to any coded stream.

In an example embodiment, the coded streams of LCEVC may be encapsulated in an LCEVC sample auxiliary information (SAI) referenced by SampleAuxiliaryInformationSizesBox and SampleAuxiliaryInformationOffsetBox, as defined in ISO/IEC 14496-12.

In an example embodiment, when the coded streams of LCEVC is encapsulated in an LCEVC SAI, the aux_info_type may be set equal to the 4cc of the configuration box to which the sample auxiliary data belong to, and aux_info_type_parameter may be set equal to 0 or 1.

In an example embodiment, when the coded streams of LCEVC is encapsulated in an LCEVC SAI, the value for aux_info_type may be ‘lvcc’.

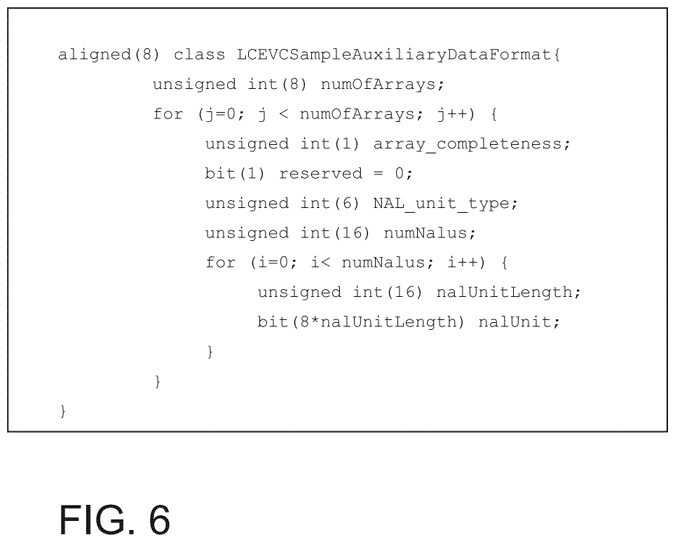

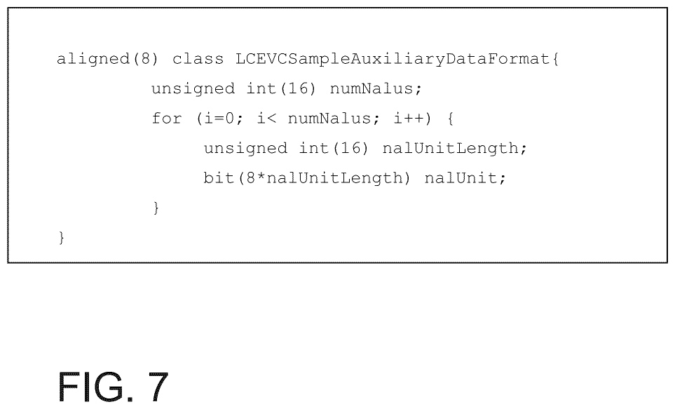

In an example embodiment, the implementation of LCEVC SAI in ISOBMFF may be as illustrated in FIG. 6. In an alternative example embodiment, the representation of LCEVC SAI may be as illustrated in FIG. 7.

The sample_info_size (found in SampleAuxiliaryInformationSizesBox) may be the size of the LCEVC SAI for this sample.

The numOfArrays may indicate the number of arrays of NAL units of the indicated type(s).

The array_completeness, when equal to 1, may indicate that all NAL units of the given type are in the following array and none are in the stream carried within the sample auxiliary information. When equal to 0, it may indicate that additional NAL units of the indicated type may be in the stream carried within the sample auxiliary information. The default and permitted values may be constrained by the sample entry name.

The NAL_unit_type may indicate the type of the data block units or NAL units in the following array (which may be all of that type). It may take a value as defined in LCEVC. It may be restricted to take one of the values indicating a sequence configuration (SC), global configuration (GC), additional info (AI), or supplemental enhancement information (SEI) data block unit.

The numNalus may indicate the number of NAL units of the indicated type included in the LCEVC SAI. Alternatively, the numNalus may indicate the number of NAL units included in the LCEVC SAI.

The nalUnitLength may indicate the length in bytes of the NAL unit.

The nalUnit may contain an NAL unit, as specified in LCEVC.

In an example embodiment, a new Sample Extension Box may be defined for storage of sample auxiliary information. In an example embodiment, the Sample Extension Box in ISOBMFF may be as shown below:
Sample extension box
Definition
Box Type: ‘saet’
Container: TrackFragmentBox or TrackBox
Mandatory: No
Quantity: Zero or one

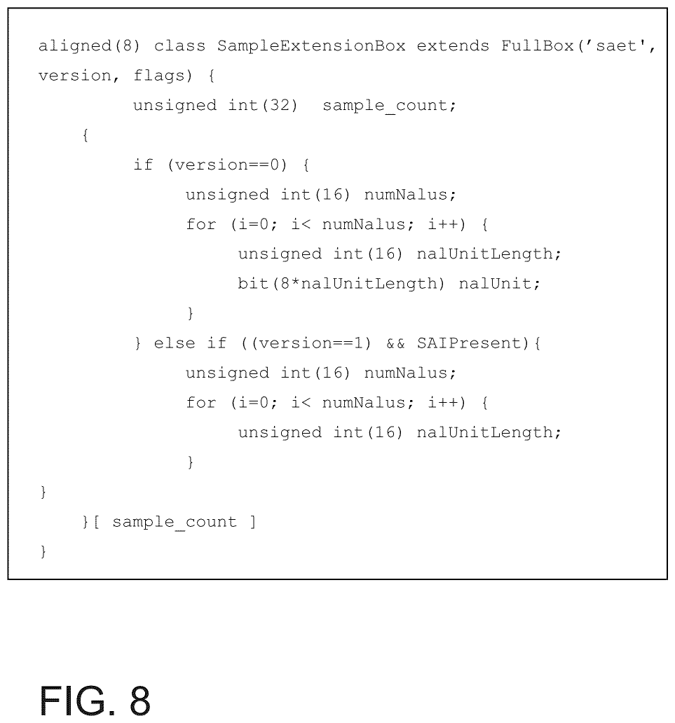

In an example embodiment, the SampleExtensionBox may provide an optional storage location for LCEVC SAI of samples in a track or track fragment. An example of SampleExtensionBox is illustrated in FIG. 8.

In an example embodiment, the storage of SampleExtensionBox in a TrackFragmentBox may make the necessary LCEVC SAI accessible within the movie fragment for all contained samples to make each track fragment independently accessible. For instance, when movie fragments are delivered as DASH media segments.

In an example embodiment, when version 0 of SampleExtensionBox is used, sample_count may be equal to the number of samples in the track or track fragment. Consequently, version 0 may not be used when selective SAI is in use.

In an example embodiment, when a version other than 0 of SampleExtensionBox is used, the SampleExtensionBox may only contain SAI for samples having their SAIPresent flag different from 0x00, either through default, or through an explicit LCEVCSampleExtensionInformationGroupEntry sample to group mapping.

In an example embodiment, the LCEVC SAI entries may be listed in the same order as samples in the track or track fragment. For example, the first entry may describe the LCEVC SAI of the first sample in the track or track fragment, regardless of the number of samples with SAIPresent flag equal to 0x00 before this sample. Consequently, for version(s) other than 0 of SampleExtensionBox, there may be no LCEVC SAI for a sample with SAIPresent different from 0x00, and the corresponding SampleAuxiliaryInformationSizesBox entry may be 0.

This may mean that, for version(s) other than 0, the index of LCEVC SAI into this box for a given sample may depend on the number of previous samples with non-zero SAIPresent. Retrieving this information through the SampleAuxiliaryInformationSizesBox and SampleAuxiliaryInformationOffsetsBox might be easier.

The sample_count may be the number of LCEVC SAI coded in the SampleExtensionBox. For version 0, it may be either 0 or the number of samples in the track or track fragment where the SampleExtensionBox is contained. For version(s) other than 0, it may be the number of samples containing the SAI in the track or track fragment where the SampleExtensionBox is contained.

Turning now to V3C (V-DMC), the requirement is to carry atlas, base mesh, and displacement bitstream in the same track. One way is by reusing the existing sample entry of the atlas track. To realize example embodiments of the present disclosure, the atlas sample entry may be reused. An example is a track with a sample entry with 4cc ‘v3c1’. Any other sample entry for V3C codec, as defined in ISO/IEC 23090-10, may be used.

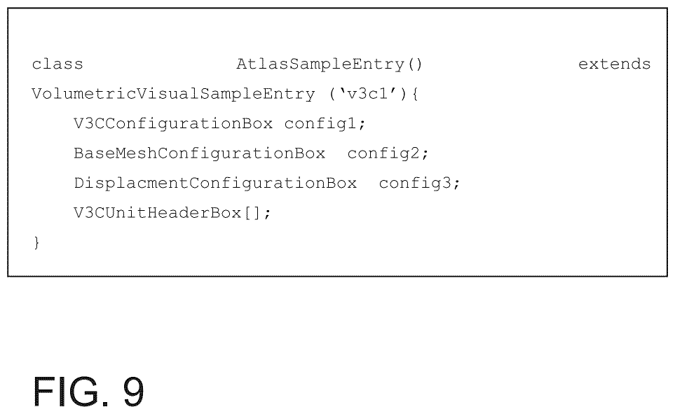

The sample entry of the atlas (base) track may contain one or more ConfigurationBoxes. One of the ConfigurationBox in the sample entry of track may the base contain DecoderConfigurationRecord for the base codec. One or more of the ConfigurationBoxes in the sample entry of the base track may contain DecoderConfigurationRecord for the one or more respective additional enhancement codecs (for example base mesh and displacement). It may also contain one or more V3C unit header boxes stored in the same order as the configuration boxes. An example syntax structure is shown in FIG. 9.

In an example embodiment, the samples of the base track may contain the data related to base codec, and the data related to second codec (base mesh) and to third codec (displacement). The data related to the second codec and third codec may be carried as part of the sample auxiliary information related to the samples of the base track.

In an example embodiment, the SampleAuxiliaryInformationSizesBox may be extended. The extension may comprise information of a sample entry. For example, the syntax illustrated in FIG. 5 may be used.

In an example embodiment, the coded streams of base mesh may be encapsulated in a base mesh sample auxiliary information (SAI) referenced by SampleAuxiliaryInformationSizesBox and SampleAuxiliaryInformationOffsetBox, as defined in ISO/IEC 14496-12.

In an example embodiment, when the coded streams of base mesh is encapsulated in a base mesh SAI, the aux_info_type may be set equal to the 4cc of the configuration box to which the sample auxiliary data belong to, and aux_info_type_parameter may be set equal to 0 or 1.

In an example embodiment, when the coded streams of base mesh may be encapsulated in a base mesh SAI, the value for aux_info_type is ‘vbmC’.

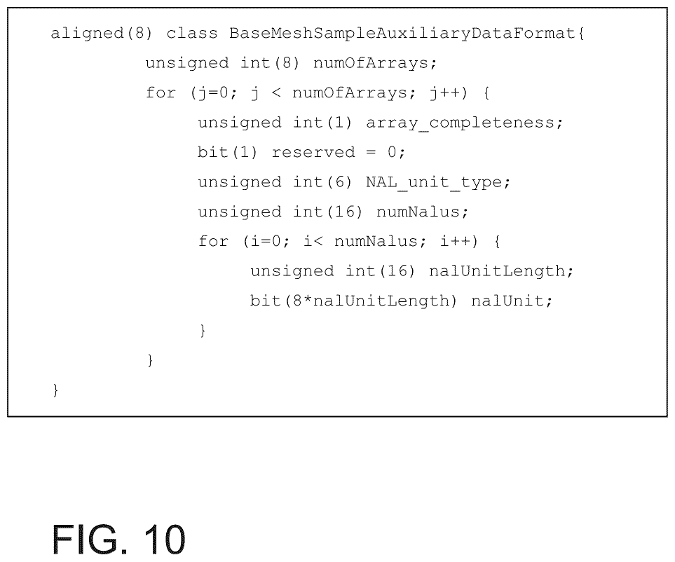

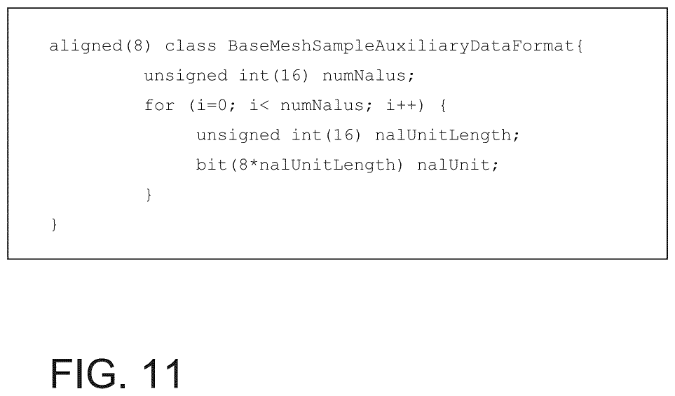

In an example embodiment, the implementation of the base mesh SAI in ISOBMFF may be as illustrated in FIG. 10. In an alternative example embodiment, the representation of the base mesh SAI may be as illustrated in FIG. 11.

The sample_info_size may be the size of the base mesh SAI for this sample.

The numOfArrays may indicate the number of arrays of NAL units of the indicated type(s).

The array_completeness, when equal to 1, may indicate that all NAL units of the given type are in the following array and none are in the stream. When equal to 0, it may indicate that additional NAL units of the indicated type may be in the stream. The default and permitted values may be constrained by the sample entry name.

The NAL_unit_type may indicate the type of the NAL units in the following array (which may all be of that type). It may take a value as defined in V-DMC. It may be restricted to take one of the values indicating a common atlas sequence parameter set, atlas sequence parameter set, V-DMC parameter set or supplemental enhancement information (SEI) data block unit.

The numNalus may indicate the number of NAL units of the indicated type included in the V-DMC SAI. Alternatively, the numNalus may indicate the number of (all) NAL units included in the V-DMC SAI.

The nalUnitLength may indicate the length in bytes of the NAL unit.

The nalUnit may contain an NAL unit, as specified in V-DMC.

In an example embodiment, a new V-DMC sample Extension Information Box may be defined for storage of V-DMC sample auxiliary information. In an example embodiment, the V-DMC sample Extension Information Box in ISOBMFF may be as shown below:
VDMC Sample extension box
Definition
Box Type: ‘vset’
Container: TrackFragmentBox or TrackBox
Mandatory: No
Quantity: Zero or one

In an example embodiment, the storage of VDMCSampleExtensionBox in a TrackFragmentBox may make the necessary base mesh SAI accessible within the movie fragment for all contained samples, which may have the technical effect of making each track fragment independently accessible. For instance, when movie fragments are delivered as DASH media segments.

In example an embodiment, when version 0 of VDMCSampleExtensionBox is used, sample_count may be equal to the number of samples in the track or track fragment. Consequently, version 0 may not be used when selective SAI is in use.

In an example embodiment, when version other than 0 of VDMCSampleExtensionBox is used, the SampleExtensionBox may only contain SAI for samples having their SAIPresent flag different from 0x00, either through default or through an explicit BaseMeshSampleExtensionInformationGroupEntry sample to group mapping.

In an example embodiment, the base mesh SAI entries may be listed in the same order as samples in the track or track fragment. For example, the first entry may describe the base mesh SAI of the first sample in the track or track fragment, regardless of the number of samples with SAIPresent flag equal to 0x00 before this sample. Consequently, for version(s) other than 0 of SampleExtensionBox, there may be no base mesh SAI for a sample with SAIPresent different from 0x00, and the corresponding SampleAuxiliaryInformationSizesBox entry may be 0.

This may mean that, for version(s) other than 0, the index of base mesh SAI into this box for a given sample may depend on the number of previous samples with non-zero SAIPresent. Retrieving this information through the SampleAuxiliaryInformationSizesBox and SampleAuxiliaryInformationOffsetsBox might be easier.

Referring now to FIG. 8, the sample_count may be the number of LCEVC SAI coded in the SampleExtensionBox. For version 0, it may be either 0 or the number of samples in the track or track fragment where the SampleExtensionBox is contained. For versions other than 0, it may be the number of samples containing the SAI in the track or track fragment where the SampleExtensionBox is contained.

Some example embodiments have been described in relation to LCEVC and/or V-DMC. It is to be understood that while LCEVC and V-DMC are specific codecs for which example embodiments may be applied, the example embodiments may generally apply to any enhancement codec used to encode a bitstream which is carried as sample auxiliary information.

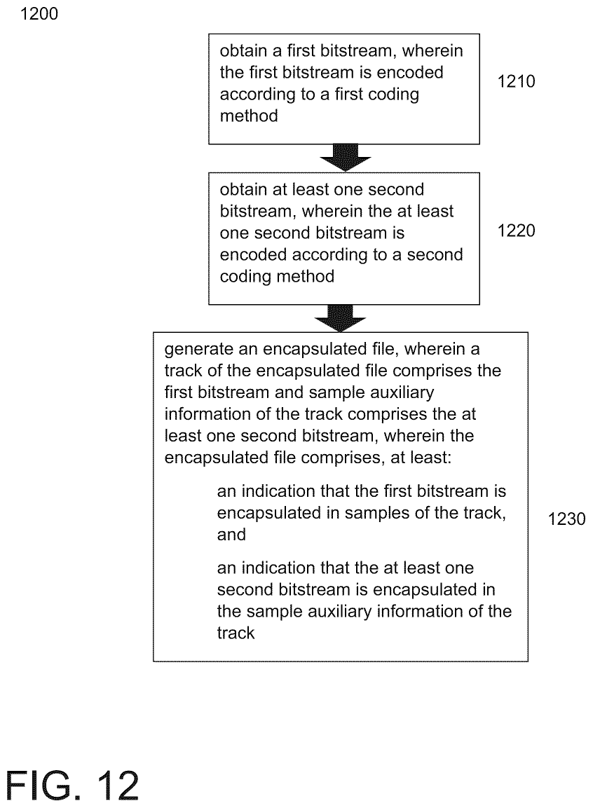

FIG. 12 illustrates the potential steps of an example method 1200. The example method 1200 may include: obtaining a first bitstream, wherein the first bitstream is encoded according to a first coding method, 1210; obtaining at least one second bitstream, wherein the at least one second bitstream is encoded according to a second coding method, 1220; and generating an encapsulated file, wherein a track of the encapsulated file comprises the first bitstream and sample auxiliary information of the track comprises the at least one second bitstream, wherein the encapsulated file comprises, at least: an indication that the first bitstream is encapsulated in samples of the track, and an indication that the at least one second bitstream is encapsulated in the sample auxiliary information of the track, 1230. The example method 1200 may be performed, for example, with a codec, an encoder, a device configured to perform the function(s) of an encoder, a UE, a network node, etc.

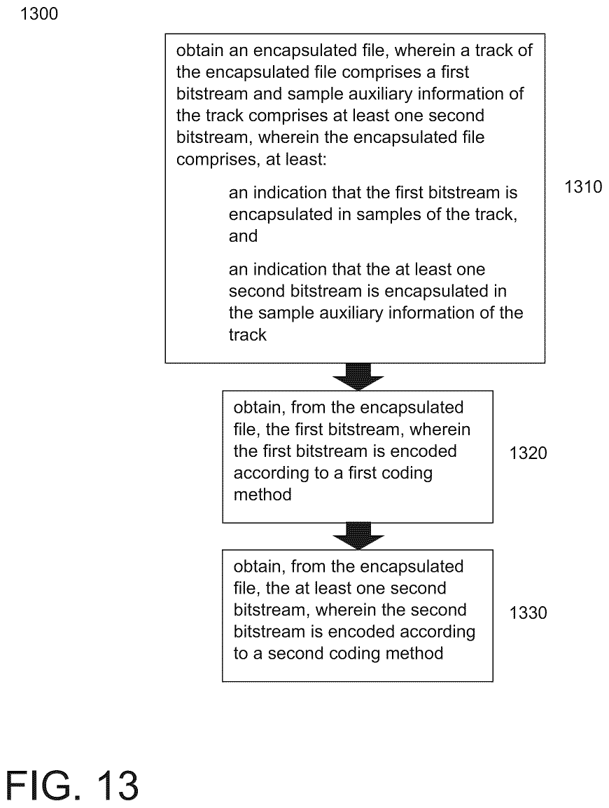

FIG. 13 illustrates the potential steps of an example method 1300. The example method 1300 may include: obtaining an encapsulated file, wherein a track of the encapsulated file comprises a first bitstream and sample auxiliary information of the track comprises at least one second bitstream, wherein the encapsulated file comprises, at least: an indication that the first bitstream is encapsulated in samples of the track, and an indication that the at least one second bitstream is encapsulated in the sample auxiliary information of the track, 1310; obtaining, from the encapsulated file, the first bitstream, wherein the first bitstream is encoded according to a first coding method, 1320; and obtaining, from the encapsulated file, the at least one second bitstream, wherein the second bitstream is encoded according to a second coding method, 1330. The example method 1300 may be performed, for example, with a codec, a decoder, a device configured to perform the function(s) of a decoder, a UE, a network node, etc.

In accordance with one example embodiment, an apparatus may comprise: at least one processor; and at least one memory storing instructions that, when executed by the at least one processor, cause the apparatus at least to: obtain a first bitstream, wherein the first bitstream may be encoded according to a first coding method; obtain at least one second bitstream, wherein the at least one second bitstream may be encoded according to a second coding method; and generate an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

In accordance with one aspect, an example method may be provided comprising: obtaining, with a user equipment, a first bitstream, wherein the first bitstream may be encoded according to a first coding method; obtaining at least one second bitstream, wherein the at least one second bitstream may be encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

In accordance with one example embodiment, an apparatus may comprise: circuitry configured to perform: obtaining a first bitstream, wherein the first bitstream may be encoded according to a first coding method; circuitry configured to perform: obtaining at least one second bitstream, wherein the at least one second bitstream may be encoded according to a second coding method; and circuitry configured to perform: generating an encapsulated file, wherein a track of the encapsulated file may comprise the first bitstream and sample auxiliary information of the track may comprise the at least second bitstream, wherein the encapsulated file may comprise, at least: an indication that the first bitstream is encapsulated in samples of the track, and an indication that the at least one second bitstream is encapsulated in the sample auxiliary information of the track.

In accordance with one example embodiment, an apparatus may comprise: processing circuitry; memory circuitry including computer program code, the memory circuitry and the computer program code configured to, with the processing circuitry, enable the apparatus to: obtain a first bitstream, wherein the first bitstream may be encoded according to a first coding method; obtain at least one second bitstream, wherein the at least one second bitstream may be encoded according to a second coding method; and generate an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog digital and/or hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: obtaining a first bitstream, wherein the first bitstream may be encoded according to a first coding method; obtaining at least one second bitstream, wherein the at least one second bitstream is encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: obtain a first bitstream, wherein the first bitstream may be encoded according to a first coding method; obtain at least one second bitstream, wherein the at least one second bitstream may be encoded according to a second coding method; and generate an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

In accordance with one example embodiment, a non-transitory computer-readable medium comprising program instructions stored thereon for performing at least the following: obtaining a first bitstream, wherein the first bitstream may be encoded according to a first coding method; obtaining at least one second bitstream, wherein the at least one second bitstream may be encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

In accordance with another example embodiment, a non-transitory program storage device readable by a machine may be provided, tangibly embodying instructions executable by the machine for performing operations, the operations comprising: obtaining a first bitstream, wherein the first bitstream may be encoded according to a first coding method; obtaining at least one second bitstream, wherein the at least one second bitstream may be encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

In accordance with another example embodiment, a non-transitory computer-readable medium comprising instructions that, when executed by an apparatus, cause the apparatus to perform at least the following: obtaining a first bitstream, wherein the first bitstream may be encoded according to a first coding method; obtaining at least one second bitstream, wherein the at least one second bitstream may be encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

A computer implemented system comprising: at least one processor and at least one non-transitory memory storing instructions that, when executed by the at least one processor, cause the system at least to perform: obtaining a first bitstream, wherein the first bitstream may be encoded according to a first coding method; obtaining at least one second bitstream, wherein the at least one second bitstream may be encoded according to a second coding method; and generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

A computer implemented system comprising: means for obtaining a first bitstream, wherein the first bitstream may be encoded according to a first coding method; means for obtaining at least one second bitstream, wherein the at least one second bitstream may be encoded according to a second coding method; and means for generating an encapsulated file, wherein a track of the encapsulated file may comprise the first bitstream and sample auxiliary information of the track may comprise the at least one second bitstream, wherein the encapsulated file may comprise, at least: an indication that the first bitstream is encapsulated in samples of the track, and an indication that the at least one second bitstream is encapsulated in the sample auxiliary information of the track.

In accordance with one example embodiment, an apparatus may comprise: at least one processor; and at least one memory storing instructions that, when executed by the at least one processor, cause the apparatus at least to: obtain an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtain, from the encapsulated file, the first bitstream, wherein the first bitstream may be encoded according to a first coding method; and obtain, from the encapsulated file, the at least one second bitstream, wherein the second bitstream may be encoded according to a second coding method.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

In accordance with one aspect, an example method may be provided comprising: obtaining, with a user equipment, an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream may be encoded according to a first coding method; and obtaining, from the encapsulated file, the at least one second bitstream, wherein the second bitstream may be encoded according to a second coding method.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

In accordance with one example embodiment, an apparatus may comprise: circuitry configured to perform: obtaining, with a user equipment, an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; circuitry configured to perform: obtaining, from the encapsulated file, the first bitstream, wherein the e first bitstream may be encoded according to a first coding method; and circuitry configured to perform: obtaining, from the encapsulated file, the at least one second bitstream, wherein the second bitstream may be encoded according to a second coding method.

In accordance with one example embodiment, an apparatus may comprise: processing circuitry; memory circuitry including computer program code, the memory circuitry and the computer program code configured to, with the processing circuitry, enable the apparatus to: obtain an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtain, from the encapsulated file, the first bitstream, wherein the first bitstream may be encoded according to a first coding method; and obtain, from the encapsulated file, the at least one second bitstream, wherein the second bitstream may be encoded according to a second coding method.

In accordance with one example embodiment, an apparatus may comprise means for: obtaining, with a user equipment, an encapsulated file, wherein a track of the encapsulated file may comprise a first bitstream and sample auxiliary information of the track may comprise at least one second bitstream, wherein the encapsulated file may comprise, at least: an indication that the first bitstream may be encapsulated in samples of the track, and an indication that the at least one second bitstream may be encapsulated in the sample auxiliary information of the track; obtaining, from the encapsulated file, the first bitstream, wherein the first bitstream may be encoded according to a first coding method; and obtaining, from the encapsulated file, the at least one second bitstream, wherein the second bitstream may be encoded according to a second coding method.

The first bitstream may comprise a base bitstream, wherein the at least one second bitstream may comprise at least one enhancement bitstream, and wherein the second coding method may comprise low complexity enhancement video coding.

A sample entry of the track may comprise an indication of a configuration for decoding the first bitstream and an indication of a configuration for decoding the at least one enhancement bitstream.

The track may comprise a base track, wherein a sample entry of the base track may comprise the first bitstream and the at least one second bitstream.

The first bitstream may comprise an atlas bitstream, wherein the at least one second bitstream may comprise at least one of: a base mesh bitstream, a displacement bitstream, or a common atlas, and wherein the second coding method may comprise at least one of: video-based dynamic mesh coding, or visual volumetric video-based coding.

The track may comprise an atlas track, wherein an atlas sample entry of the atlas track may comprise the first bitstream and the at least one second bitstream.

The encapsulated file may further comprise at least one of: an indication of a configuration for decoding the first bitstream, or an indication of a configuration for decoding the second bitstream.

The first coding method may be at least partially different from the second coding method.

The first coding method and the second coding method may comprise different layers of a same coding method.

In accordance with one example embodiment, a non-transitory computer-readable medium comprising instructions stored thereon which, when executed with at least one processor, cause the at least one processor to: obtain an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtain, from the encapsulated file, the first bitstream, wherein the first bitstream may be encoded according to a first coding method; and obtain, from the encapsulated file, the at least one second bitstream, wherein the second bitstream may be encoded according to a second coding method.

In accordance with one example embodiment, a non-transitory computer-readable medium comprising program instructions stored thereon for performing at least the following: obtaining an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream may be encoded according to a first coding method; and obtaining, from the encapsulated file, the at least one second bitstream, wherein the second bitstream may be encoded according to a second coding method.

In accordance with another example embodiment, a non-transitory program storage device readable by a machine may be provided, tangibly embodying instructions executable by the machine for performing operations, the operations comprising: obtaining an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtaining, from the encapsulated file, t first bitstream, wherein the first bitstream may be encoded according to a first coding method; and obtaining, from the encapsulated file, the at least one second bitstream, wherein the second bitstream may be encoded according to a second coding method.

In accordance with another example embodiment, a non-transitory computer-readable medium comprising instructions that, when executed by an apparatus, cause the apparatus to perform at least the following: obtaining an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; obtaining, from the encapsulated file, the first bitstream, wherein the first bitstream may be encoded according to a first coding method; and obtaining, from the encapsulated file, the at least one second bitstream, wherein the second bitstream may be encoded according to a second coding method.

A computer implemented system comprising: at least one processor and at least one non-transitory memory storing instructions that, when executed by the at least one processor, cause the system at least to perform: obtaining an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of track; the obtaining, from the encapsulated file, the first bitstream, wherein the first bitstream may be encoded according to a first coding method; and obtaining, from the encapsulated file, the at least one second bitstream, wherein the second bitstream may be encoded according to a second coding method.

A computer implemented system comprising: means for obtaining an encapsulated file, wherein a track of the encapsulated file may comprise a first bitstream and sample auxiliary information of the track may comprise at least one second bitstream, wherein the encapsulated file may comprise, at least: an indication that the first bitstream is encapsulated in samples of the track, and an indication that the at least one second bitstream is encapsulated in the sample auxiliary information of the track; means for obtaining, from the encapsulated file, the first bitstream, wherein the first bitstream may be encoded according to a first coding method; and means for obtaining, from the encapsulated file, the at least one second bitstream, wherein the second bitstream may be encoded according to a second coding method.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one non-transitory memory storing instructions that, when executed by the at least one processor, cause the apparatus at least to:
obtain a first bitstream, wherein the first bitstream is encoded according to a first coding method;
obtain at least one second bitstream, wherein the at least one second bitstream is encoded according to a second coding method; and
generate an encapsulated file, wherein a track of the encapsulated file comprises the first bitstream and sample auxiliary information of the track comprises the at least one second bitstream, wherein the encapsulated file comprises, at least:
an indication that the first bitstream is encapsulated in samples of the track, and
an indication that the at least one second bitstream is encapsulated in the sample auxiliary information of the track.

2. The apparatus of claim 1, wherein the first bitstream comprises a base bitstream, wherein the at least one second bitstream comprises at least one enhancement bitstream, and wherein the second coding method comprises low complexity enhancement video coding.

3. The apparatus of claim 1, wherein the first bitstream comprises an atlas bitstream, wherein the at least one second bitstream comprises at least one of:
a base mesh bitstream,
a displacement bitstream, or
a common atlas,
and wherein the second coding method comprises at least one of:
video-based dynamic mesh coding, or
visual volumetric video-based coding.

4. The apparatus of claim 3, wherein the track comprises an atlas track, wherein an atlas sample entry of the atlas track comprises the first bitstream and the at least one second bitstream.

5. The apparatus of claim 1, wherein the encapsulated file further comprises at least one of:
an indication of a configuration for decoding the first bitstream, or
an indication of a configuration for decoding the second bitstream.

6. The apparatus of claim 1, wherein the first coding method is at least partially different from the second coding method.

7. The apparatus of claim 1, wherein the first coding method and the second coding method comprise different layers of a same coding method.

8. A method comprising:
obtaining, with a user equipment, a first bitstream, wherein the first bitstream is encoded according to a first coding method;
obtaining at least one second bitstream, wherein the at least one second bitstream is encoded according to a second coding method; and
generating an encapsulated file, wherein a track of the encapsulated file comprises the first bitstream and sample auxiliary information of the track comprises the at least one second bitstream, wherein the encapsulated file comprises, at least:
an indication that the first bitstream is encapsulated in samples of the track, and
an indication that the at least one second bitstream is encapsulated in the sample auxiliary information of the track.

9. The method of claim 8, wherein the encapsulated file further comprises at least one of:
an indication of a configuration for decoding the first bitstream, or
an indication of a configuration for decoding the second bitstream.

10. A non-transitory computer-readable medium comprising program instructions stored thereon for performing at least the following:
obtaining a first bitstream, wherein the first bitstream is encoded according to a first coding method;
obtaining at least one second bitstream, wherein the at least one second bitstream is encoded according to a second coding method; and
generating an encapsulated file, wherein a track of the encapsulated file comprises the first bitstream and sample auxiliary information of the track comprises the at least one second bitstream, wherein the encapsulated file comprises, at least:
an indication that the first bitstream is encapsulated in samples of the track, and
an indication that the at least one second bitstream is encapsulated in the sample auxiliary information of the track.

11. An apparatus comprising:
at least one processor; and
at least one non-transitory memory storing instructions that, when executed by the at least one processor, cause the apparatus at least to:
obtain an encapsulated file, wherein a track of the encapsulated file comprises a first bitstream and sample auxiliary information of the track comprises at least one second bitstream, wherein the encapsulated file comprises, at least:
an indication that the first bitstream is encapsulated in samples of the track, and
an indication that the at least one second bitstream is encapsulated in the sample auxiliary information of the track;
obtain, from the encapsulated file, the first bitstream, wherein the first bitstream is encoded according to a first coding method; and
obtain, from the encapsulated file, the at least one second bitstream, wherein the second bitstream is encoded according to a second coding method.

12. The apparatus of claim 11, wherein the first bitstream comprises a base bitstream, wherein the at least one second bitstream comprises at least one enhancement bitstream, and wherein the second coding method comprises low complexity enhancement video coding.

13. The apparatus of claim 11, wherein the first bitstream comprises an atlas bitstream, wherein the at least one second bitstream comprises at least one of:
a base mesh bitstream,
a displacement bitstream, or
a common atlas,
and wherein the second coding method comprises at least one of:
video-based dynamic mesh coding, or
visual volumetric video-based coding.

14. The apparatus of claim 13, wherein the track comprises an atlas track, wherein an atlas sample entry of the atlas track comprises the first bitstream and the at least one second bitstream.

15. The apparatus of claim 11, wherein the encapsulated file further comprises at least one of:
an indication of a configuration for decoding the first bitstream, or
an indication of a configuration for decoding the second bitstream.

16. The apparatus of claim 11, wherein the first coding method is at least partially different from the second coding method.

17. The apparatus of claim 11, wherein the first coding method and the second coding method comprise different layers of a same coding method.

18. A method comprising:
obtaining, with a user equipment, an encapsulated file, wherein a track of the encapsulated file comprises a first bitstream and sample auxiliary information of the track comprises at least one second bitstream, wherein the encapsulated file comprises, at least:
an indication that the first bitstream is encapsulated in samples of the track, and
an indication that the at least one second bitstream is encapsulated in the sample auxiliary information of the track;
obtaining, from the encapsulated file, the first bitstream, wherein the first bitstream is encoded according to a first coding method; and
obtaining, from the encapsulated file, the at least one second bitstream, wherein the second bitstream is encoded according to a second coding method.

19. The method of claim 18, wherein the encapsulated file further comprises at least one of:
an indication of a configuration for decoding the first bitstream, or
an indication of a configuration for decoding the second bitstream.

20. A non-transitory computer-readable medium comprising program instructions stored thereon for performing at least the following:
obtaining an encapsulated file, wherein a track of the encapsulated file comprises a first bitstream and sample auxiliary information of the track comprises at least one second bitstream, wherein the encapsulated file comprises, at least:
an indication that the first bitstream is encapsulated in samples of the track, and
an indication that the at least one second bitstream is encapsulated in the sample auxiliary information of the track;
obtaining, from the encapsulated file, the first bitstream, wherein the first bitstream is encoded according to a first coding method; and
obtaining, from the encapsulated file, the at least one second bitstream, wherein the second bitstream is encoded according to a second coding method.
